(19) United States
(12) Patent Application Publication
(10) Pub. No.: US 2005/0278205 A1
(43) Pub. Date: Dec. 15, 2005

(54) Network-Employing Matching System in Providing Information on Positions/Help Wanted and Related Information

(75) Inventor: Hirotoshi Kato, Shinjuku-ku (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: PA CO., LTD., Shinjuku-ku, Tokyo (JP)

(21) Appl. No.: 11/160,138

(22) Filed: Jun. 10, 2005

(30) Foreign Application Priority Data
Jun. 11, 2004 (JP) JP-2004-174850

(51) Int. Cl. G06F 17/60

(52) U.S. Cl. 705/7

(57) ABSTRACT

On websites devoted to help-/positions-wanted information, highly matching help-wanted information is made available to job-seekers. Sites devoted to positions-/help-wanted information are set up on a network, and on the one side, hiring businesses provide help-wanted information and solicited information through the specialty site, and on the other side, through the specialty sites or various other sites, job-seekers/certification candidates input résumés and solicited information. The parties on both sides input a number of rankings on items they wish to prioritize among the solicited information, and a control system automatically matches and digitizes these input information items, i.e., the hiring businesses' recruiting information with the job-seekers'/certification candidates' solicited information. The digitized values equal to or greater than a fixed value are displayed per hiring businesses' recruiting information. Subsequently, the hiring businesses' solicited information and the job-seekers'/certification candidates' résumés are matched against those digitized values, and the results are digitized and displayed to determine how far off the fit is on either side, thereby supporting the job-application process.

### BACKGROUND OF THE INVENTION

1. Technical Field

The present invention relates to Internet-employing or other network-employing systems that match information in providing positions and help wanted and related information.

2. Description of the Related Art

In order to secure capable personnel, the average corporate organization traditionally has carried out techniques such as providing help-wanted information to job seekers by, for example, posting help-wanted ads in newspapers or other print media, or by advertising help-wanted information in recruiting magazines.

In another technique that is being carried out—one which has been developed in recent years—companies set up their own websites on the Internet and, by posting help-wanted information on the sites, provide help-wanted information to job seekers. This means of providing help-wanted information is conducted by companies posting help-wanted information on their sites, and by job seekers obtaining the help-wanted information by browsing for such information via the Internet, and responding by telephone, e-mail, etc., to the help-wanted information. The average corporate organization will make hiring decisions by screening documents from and conducting interviews with job applicants.

Meanwhile, in Japanese Unexamined Pat. App. Pub. No. 2003-30314, a system has been proposed in which businesses' help-wanted information is registered on intermediaries' Web servers. Job seekers search the registered help-wanted information and the search results are transmitted to the job seekers.

In the aforementioned system, the job seekers themselves search the help-wanted information, but in Japanese Unexamined Pat. App. Pub. No. 2003-162651, a system that matches registered job-seekers' résumés with help-wanted information items has been proposed.

In Japanese Unexamined Pat. App. Pub. No. 2003-281400, furthermore, a system that matches job-seeker-registered résumé items with help-wanted information items, displays as a percentage the extent to which the items fit, and outputs help-wanted information matching at 80% or better, has been proposed.

Still further, proposed in Japanese Unexamined Pat. App. Pub. No. 2002-334147 is a system that registers, and in advance assigns scores to, search items and help-wanted information that job seekers have selected on the Web. The system also records and assigns scores to registered résumés. From the scores for each of these items, the system automatically retrieves help-wanted information, with the top-ten ranking items as the retrieve items.

For items that are matched, Japanese Unexamined Pat. App. Pub. Nos. H11-338879, 2001-142939, and 2002-163475 propose using individual-skill data presented by job seekers, using career data including a job seeker's qualifications and curriculum vitae, and carrying out job seeking and job offering that involves licensed information processing technicians in particular.

In addition, Japanese Unexamined Pat. App. Pub. Nos. 2002-163475, 2002-163475, and 2002-163475 propose systems that lay stress on wages, such as a monthly wage, hourly wage, wage scale, etc., for items that are matched.

Still further, Japanese Unexamined Pat. App. Pub. Nos. 2002-230138, 2002-149795, 2001-265874, and 2002-189875 propose systems that lay stress on commuting time by a job seeker's desired means of transportation, on geographical range, on work location, or on hiring businesses' recruiting of workers in real time.

Matching systems that include various tests were also proposed.

For example, Japanese Unexamined Pat. App. Pub. No. 2001-319079 proposes a matching system in which examinations for a plurality of subjects are given to job seekers; the answers for each subject and information about their desired jobs are gained and suitable job seekers, after checking out help-wanted information, are then introduced to a hiring business. Japanese Unexamined Pat. App. Pub. No. 2002-157450 proposes a system in which job seekers answer questions from the system and then suitable job types and careers are combined. Japanese Unexamined Pat. App. Pub. No. 2002-203030 proposes a system in which results of qualifications tests are registered at a server, and a hiring business accesses the server to search for information about human resources suitable for its hiring conditions; then the server searches for and picks up the information, and sends a list of the information and each person's résumé and qualification test results, etc., to the hiring business.

Furthermore, a job-placement system is proposed in Japanese Unexamined Pat. App. Pub. No. 2004-021908. The system is used for internship contracts which have a temporary employment period in advance of a formal contract. Types of companies and samples of expected applicants (sample category for making a table: high performer) are selected, and the scales for evaluating the person are made into questions, with each person being classified by the scales according to a cluster. A control system makes a list of job seekers using prepared functions to classify the job seekers. The hiring businesses select job seekers based on the list.

However, these conventional means have the following disadvantages.

As for the matching system between a job seeker's résumé and help-wanted information, a résumé presents only the current status of the job seeker; therefore, it does not reflect prospective work, annual income, or business types targeted by the job seeker.

In cases in which the matching points between résumés and help-wanted information are shown as a percent, that number only reflects the matching of items. For example, if the first choice of a desired job type is project manager and the second choice is system engineer, depending on the conditions, this system may not be useful because the subjects that exclude project manager cannot be searched.

In addition to problems with matching between résumés and help-wanted information, matching between selected and recorded search items and help-wanted information on the Web may not entirely match the job seeker's target.

In addressing these disadvantages, even adding data regarding particular skills, such as adding the title of Information Processing Engineer, has the disadvantage of decreasing the degree of matching, because Information Processing Engineer is only one of numerous such certifications. Further, a person of high potential may not always have such certifications.

Also, in the above systems, not all potential human resources can be matched because limiting salary, commuting time, and geographical sites makes the selection range narrower for the hiring business.

For example, due to the shortage of IT-related engineers, recruiting activities for those positions are done not only domestically but also internationally. In these cases, the above systems become barriers.

The applicant in the present case filed a patent application, published as Japanese Pat. App. No. 2004-134927, for a system for providing information about positions/help wanted through a general system, comprising a server for a specialized site devoted to information about positions/help wanted that is connected to a network, and various sites connected to the network, in which the server has an interface, control system, and database, in which the interface is browsable by personal computer, mobile terminal, etc., and the control system keeps information regarding job offers, recruiting, and related information updated constantly, and provides the information to an interface through a database, and in which sites are provided the equivalent display items of the information provided at the interface of the server by the control system, so that the interface open to the network is placed not only on the server but also on the various sites.

The applicant in the present case has also filed a patent application, published as Japanese Unexamined Pat. App. Pub. No. 2001-151039, for a system for evaluating anonymous information while providing information about positions/help wanted through a general system, in which a specialized site for information about positions/help wanted is set up on a network, in which a system for providing similar information at various sites is constructed, in which a hiring business enters help-wanted information at the specialized site for information about positions/help wanted and also provides help-wanted information at various other sites, in which job seekers/certification candidates can enter anonymous information about job seeking and applying for certification at the specialized site for information about positions/help wanted, and can apply to the hiring business and have interviews, in which logs of applications, interviews, etc., completed by job seekers/certification candidates and various notices sent by hiring businesses are automatically tallied and displayed at the specialized site for information about positions/help wanted, in which similar information is also provided at various other sites, and in which hiring businesses browse information from anonymous job seekers/certification candidates, make conclusions regarding their skills, and evaluate the information about anonymous job seekers/certification candidates based on that tallied data, and furthermore, the invention is characterized by having two types of databases: one of personal data and one of résumés and other information.

### BRIEF SUMMARY OF THE INVENTION

In the present invention, general affairs companies, job-placement agencies, temporary-employment agencies, and education-related entities such as high schools, junior colleges, four-year colleges, technical-vocational schools, or other training institutions are all referred to as hiring businesses.

The first problem to be solved by the invention is, using specialty sites for information about positions/help wanted, to automatically match, based on job seekers' wishes, help-wanted information desired by the job seekers, and to show numerically the degree of matching, and also to show numerically the degree of matching based on the wishes of the hiring business and the job seeker's present skill, to automatically provide highly matched help-wanted information to job seekers and eliminate mismatched applications.

The second problem to be solved by the invention is, using specialty sites for information about positions/help wanted, to automatically match, based on a hiring business's wishes, job seekers desired by the hiring business, and to show numerically the degree of matching, and also to show numerically the degree of matching based on the wishes of the job-seeker and the hiring conditions of the hiring business, to automatically provide highly matched job seekers to hiring businesses and eliminate mismatched nominations.

The third problem to be solved by the invention is to provide information to the hiring businesses and job seekers/certification candidates by efficiently using the network when providing information about job offers, job seeking, recruiting students, and other information on the Web, and to automatically match help-wanted information desired by a job seeker based on the job seeker's wishes, and to show numerically the degree of matching, and also to show numerically the degree of matching based on the wishes of the hiring business and the job seeker's present skills, to automatically provide highly matched help-wanted information to job seekers and eliminate mismatched applications.

The fourth problem to be solved by the invention is to automatically match help-wanted information desired by a job seeker based on the job seeker's wishes using specialty sites for information about positions/help wanted, and to show numerically the degree of matching, and also to show numerically the degree of matching based on the wishes of the hiring business and the job seeker's present skills, to automatically provide highly matched help-wanted information to job seekers, and to promote applications under their real names or under anonymity, and to evaluate anonymous applicants to determine if they really exist, and to determine if information such as personal data, résumés, and curriculum vitae is correct at the time that the anonymous application is received.

The fifth problem to be solved by the invention is to automatically match job seekers desired by hiring businesses based on a hiring business's wishes using the specialized site for information about positions/help wanted, and to show numerically the degree of matching, and also to show numerically the degree of matching based on the wishes of the job seeker and the hiring conditions of the hiring business to automatically provide highly matched job seekers to hiring businesses, to promote nominations, and to evaluate applicants to determine if they really exist, and to determine if information such as personal data, résumés, and curriculum vitae is correct at the time the hiring business browses information about job seekers and nominates them.

The sixth problem to be solved by the invention is to provide information to the hiring businesses and job seekers/certification candidates by efficiently using the network when providing information about job offers, job-seeking, recruiting students, and other information on the Web, and to automatically match help-wanted information desired by a job seeker based on the job seeker's wishes, and to show numerically the degree of matching, and also to show numerically the degree of matching based on the wishes of the hiring business and the job seeker's present skills, to automatically provide highly matched help-wanted information to job seekers, and to promote applications under their real names or under anonymity, and to evaluate anonymous applicants to determine if they really exist, and to determine if information such as personal data, résumés, and curriculum vitae is correct at the time the anonymous application is received.

Means for Solving the Problem

A matching system for providing information about positions/help wanted, recruiting, and other related information through a network is characterized in that:

the specialized site for information about positions/help wanted is set up on a server connected to a network such as the Internet,
in which the server has an interface, control system, and database,
in which the interface is open to the network, and comprising web pages browsable by personal computer (hereinafter referred to as PC), mobile terminal, etc.,
in which the web pages post necessary information about positions/help wanted, improving careers and skills, etc., and have various registration buttons, etc.,
in which a hiring business enters help-wanted information such as information about job offers and solicited information, etc., at the specialized site for information about positions/help wanted, and also enters prioritized items with plural ranks among the solicited information,
in which job seekers/certification candidates enter résumés, curriculum vitae, and solicited information, etc., at the specialized site for information about positions/help wanted, and also enter prioritized items with plural ranks among the solicited information,
in which at the specialized site for information about positions/help wanted, based on the input data, the control system automatically matches the information about hiring business recruitment with solicited information from job seekers/certification candidates, and shows numerically the degree of matching, and the figures exceeding a fixed value are displayed for each set of information regarding hiring business recruitment,
and subsequently to those figures exceeding a fixed value, the control system automatically matches solicited information from the hiring business with résumés and curriculum vitae of job seekers/certification candidates, shows numerically the degree of matching, and displays the figures for each set of information regarding r hiring business recruitment, which also shows any discrepancy between targets of job seekers and those of hiring businesses and thus, supports the application procedures.

A matching system for providing information about positions/help wanted, recruiting, and other related information through a network is characterized in that not only the specialized site for information about positions/help wanted but also web pages on various sites are provided the same information as the server provides by via the control system posting information at the interface of the server.

The various sites are searchable and browsable by PC, mobile terminal, etc., portal sites, news sites, and other sites.

A matching system concerning information under real names or under anonymity for providing information about positions/help wanted, recruiting, and other related information through a network is characterized in that the job seeker/certification candidate enters information about job-seeking and desired certifications under his/her name or under anonymity at the specialized site for information about positions/help wanted, and recruiting and at various other sites, and if he/she finds suitable information about job offers and certifications, he/she can make an application to the hiring business and have interviews under his/her name or under anonymity using the application system, in which logs of applications, interviews, etc., done by job seekers/certification candidates and various notices sent by hiring businesses are automatically calculated and displayed at the specialized site for information about positions/help wanted as well as at various other sites,
in which at the specialized site for information about positions/help wanted, based on input data with plural ranks as prioritized items among solicited information from both the hiring business and the job seeker/certification candidate, the control system of the specialized site for information about positions/help wanted automatically matches the information about recruitment desired by the job seeker/certification candidate and shows numerically the degree of matching, and the figures are displayed for each set of information, and also displayed in various other sites.

In the matching system for information about positions/help wanted through a network of the present invention, the job seeker can apply not only under his/her name but also under anonymity, because he/she is provided help-wanted information about the company, including the numbers of applications and interviews received by the hiring business, so that he/she learns the company more accurately.

The job seeker can apply without worrying about leaks of personal data because there are two different databases, one with personal data and one with résumés and curriculum vitae.

Furthermore, by showing numerically the degree of matching between the target of the job seeker and the hiring conditions of the hiring business, and at the same time showing numerically the degree of matching between the target of the hiring business and the experience and skills of the job seeker, the job seeker can determine the expected degree of matching between the job seeker and the hiring business, can eliminate mismatched applications, and can receive fewer mismatched nominations from hiring businesses. As a result, job-seeking activities become more effective and lead to a stronger probability of success for joining the company.

The hiring businesses can determine whether the job seeker really exists and whether the registered data are correct by being provided evaluation data, including the numbers of applications, interviews, etc., given to the job seeker.

By showing numerically the degree of matching between the target of the job seeker and the hiring conditions of the hiring business, and at the same time showing numerically the degree of matching between the target of the hiring business and the experience and skills of job seeker, the hiring businesses may determine the expected degree of matching between the job seeker and the hiring business, eliminate mismatched nominations, and receive fewer mismatched applications from job seeker, thus increasing the probability of success in gaining new employees.

By putting web pages not only in Server but also in plurality of various sites, even if the job seeker applies at various sites, the target of the job seeker and the hiring conditions of selected help-wanted information are shown numerically, and at the same time the degree of matching between the conditions of the selected help-wanted information and the experience and skills of job seeker is shown numerically so that he/she can make a decision more accurately.

Also, the job seeker can receive more help-wanted information and file more applications because the information, by being matched automatically, is provided at various sites and at the server.

The hiring business can provide help-wanted information to many more job seekers not only in Server 1 but also in various other sites and can reduce the number of hiring procedures because once the business registers help-wanted information at the server, it can also provide the information at the various sites.

From the following detailed description, in conjunction with the accompanying drawings, the foregoing and other objects, features, aspects, and advantages of the present invention will become readily apparent to those skilled in the art.

### BRIEF DESCRIPTION OF THE SEVERAL VIEWS OF THE DRAWINGS

FIG. 1 is a schematic diagram showing the general system of the invention;

FIG. 2 is an example of a screen page for the interface browsable by personal computer A1;

FIG. 3 is Flowchart 1 showing a registration process at the specialized site for information about positions/help wanted by job seekers/certification candidates;

FIG. 4 is Flowchart 2 showing a registration process at the specialized site for information about positions/help wanted by job seekers/certification candidates;

FIG. 5 is an example of a screen page for My Page for companies;

FIG. 6 is Flowchart 1 showing a registration process for a hiring business at the specialized site for information about positions/help wanted;

FIG. 7 is Flowchart 2 showing a registration process for a hiring business at the specialized site for information about positions/help wanted;

FIG. 8 is Flowchart 3 showing a registration process for a hiring business at the specialized site for information about positions/help wanted;

FIG. 9 is Flowchart 4 showing a registration process for a hiring business at the specialized site for information about positions/help wanted;

FIG. 10 is Flowchart 1 showing a process carried out by job seekers;

FIG. 11 is Flowchart 2 showing a process carried out by job seekers;

FIG. 12 is Flowchart 1 showing a method carried out by hiring businesses;

FIG. 13 is Flowchart 2 showing a method carried out by hiring businesses;

FIG. 14 is charts setting forth, in Chart 1, “Job seekers'/Certification Candidates' Evaluation Data on Hiring Companies,” and in Chart 2, “Hiring Companies' Evaluation Data on Job seekers/Certification Candidates”; and

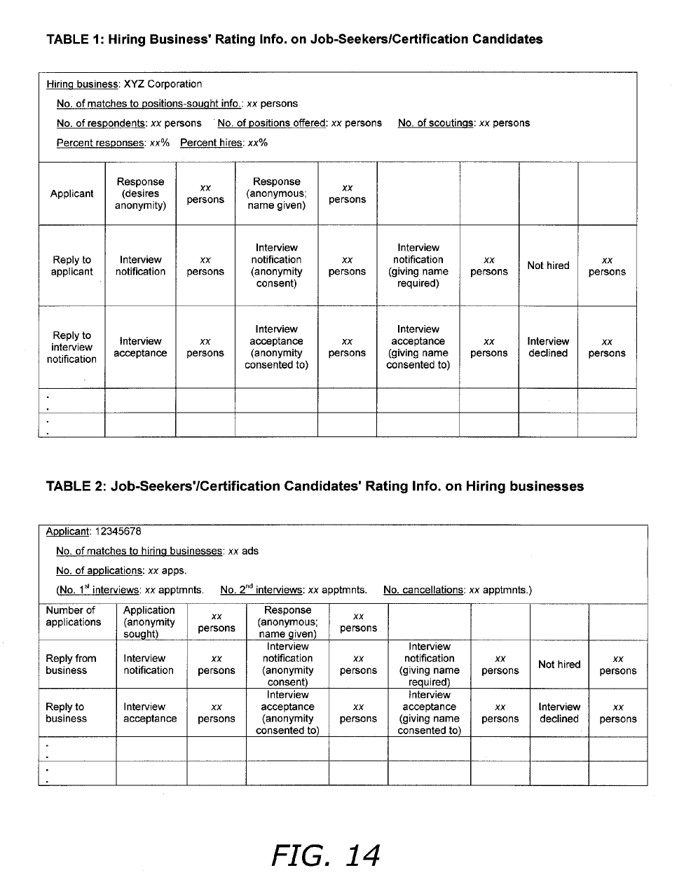

FIG. 15 is charts setting forth, in Chart 3, a “Score Table (D11),” in Chart 4, a “weighting Table (D12),” in Chart 5, a “Recruiting Information/Course Information List,” and in Chart 6, a “Positions Wanted Information List.”

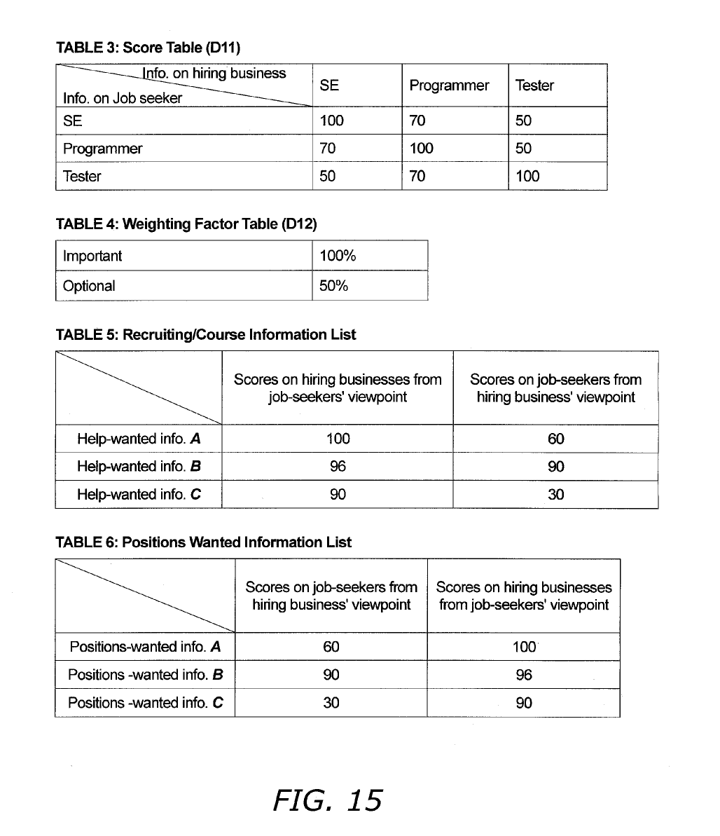

### DETAILED DESCRIPTION OF THE INVENTION

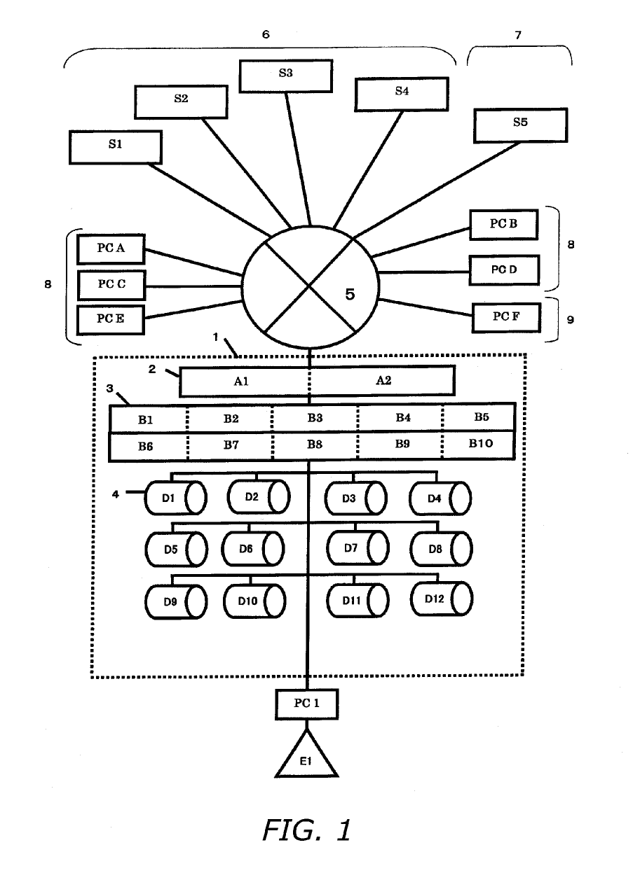

The general system of the invention is shown as FIG. 1.

First, Server 1 for the specialized site for information about positions/help wanted has Interface 2, Control System 3, and Database 4.

Interface 2 comprises interface A1, browsable by personal computer, and interface A2, browsable by mobile terminal, PHS, PDA, etc., and comprising web pages open to the network 5 to be browsed.

The web page displays necessary information such as information about positions/help wanted, job placement, temporary staffing, student recruiting, mock examinations and related information, e-learning information, including web based training, and information about improving careers and skills, etc., and has various register buttons.

These web pages are created as HTML files by known software applications for building homepages such as HOMEPAGE BUILDER (registered trademark of IBM), Golive (registered trademark of Adobe), and any HTML editor. In addition, XSLT (XML Stylesheet Language Transform) files are created by known programs such as Dreamweaver (registered trademark of Macromedia) and style sheet editor. These files are saved in Server 1.

Control System 3 comprises: control system B1 for functions relating to job seekers/certification candidates; control system B2 for functions relating to hiring businesses; control system B3 for providing information about recruitment, courses, seminars, mock examinations, etc., to various sites; sales control system B4; control system B5 for application points; control system B6 for users' various logs; page generator B7 for various sites; page generator B8 for hiring businesses' own sites; control system B9 for managing pre- and post-interview evaluations both by job seekers/certification candidates and hiring businesses; and control system B10 for matching processes.

Database 4 includes: database D1 of personal data on job seekers/certification candidates, and IDs, passwords, and e-mail addresses for the personal data; job seekers'/certification candidates' database D2 of résumés, curriculum vitae, and solicited information, as well as IDs and passwords differing from IDs and passwords in connection with personal information; database D3 of IDs, passwords, e-mail addresses of hiring businesses; database D4 of hiring businesses' information; database D5 of information about recruitments and solicited information; database D6 of information about seminars and solicited information, database D7 of users' various logs; a sales database D8; database D9 of application points; database D10 of pre- and post-interview evaluations both by job seekers/certification candidates and hiring businesses; score-table database D11; and weighting database D12.

The above-described system structuring is done by a system administrator E1 carrying out configurational operations directly on Server 1 or through Personal Computer PC1 connected to Server 1.

The above-mentioned system architecture is built by System administrator E1, manipulating directly Server 1 or Personal Computer PC1 connected to Server 1.

### EMBODIMENT 1

The general system of the present invention is shown as FIG. 1, as mentioned above. Server 1 for the specialized site for information about positions/help wanted has Interface 2, Control System 3, and Database 4.

Interface 2 comprises interface A1, browsable by PC, and interface A2, browsable by mobile terminal, PHS, PDA, etc., and comprising browsable web pages open to the network 5.

The web pages of Interface 2 have a button for registering a company's information, a button for registering various other information, a button for posting at various sites, a button for posting at Server 1, a button for registering IDs, passwords, and e-mail addresses of job seekers/certification candidates, a button for applying and registering résumés and curriculum vitae, a Yes button, and a Send button for sending information to a job seeker/certification candidate and the hiring business.

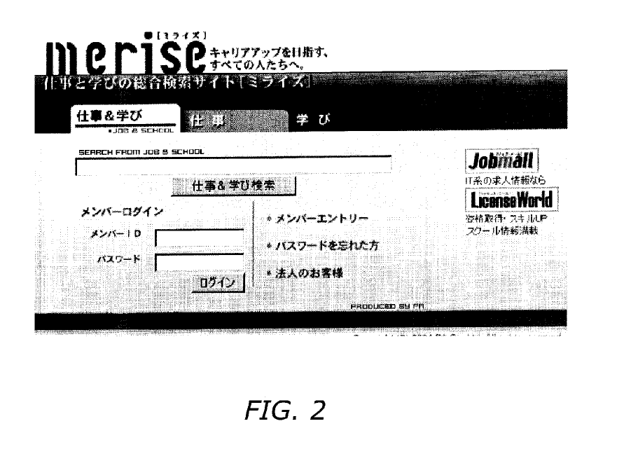

An example of the front page of Interface A1, browsable by PC, is shown as FIG. 2.

Control System 3 provides information about recruitment, courses, seminars, mock examinations, and other information, keeping the information updated constantly, via Database 4 to the web pages of interface 2, and a mail delivery system of Control System 3 accepts registration of mail delivery to provide information about recruitment, courses, seminars, mock examinations, and other information; the registration may be stored in Database 4 at the same time by clicking the Register button for mail delivery.

At various other sites 6, control system B3 of Control System 3 provides interface 2 of Server 1, and the same information provided at Server 1 is also provided at various sites 6; also, the sites accept registration of mail delivery to provide information about recruitment, courses, seminars, mock examinations, and other information, and stores it in Database 4 of Server 1 at the same time; the information may be delivered by clicking the button for mail delivery.

### EMBODIMENT 2

Entering prioritized items with plural ranks:

Next, Embodiment 2 uses the general system of Embodiment 1. A job seeker registers résumés, curriculum vitae, and solicited information, and also enters prioritized items with plural ranks among solicited information. In the following example, two priority ranks of “important” and “optional” are set up as examples.

On the other hand, the hiring business registers information about recruitment and seminars, and also enters priority ranks, such as “important” or “optional”, in prioritized items among solicited information.

The job seeker logs into My Page, and then ties items designated “important” and “optional” in the job seeker's registered solicited information in with recruiting information and seminar information in common with these designated items.

Based on the corresponding items, a score is calculated and recruiting information and seminar information with a score exceeding N points are searched and displayed.

Furthermore, in addition to the searched information about recruitment and seminars, items designated “important” and “optional” in the solicited information are connected with the corresponding items of résumés or curriculum vitae of the job seeker.

Based on the corresponding items, a score is calculated and displayed.

In this way, the job seeker's targeted help-wanted information, seminars, etc., is matched automatically, and the degree of matching is shown numerically as scores, and also the degree of matching to job seekers from the standpoint of the hiring business is shown numerically as scores that can show discrepancies between targets of job seekers and the hiring business and thus, support the application procedures.

The process is as follows.

(1) The job seeker accesses Interface A1, browsable by PC, and Interface A2, browsable by mobile terminal, of Interface 2 via Network 5 with PCA-D, enters an ID, password, and e-mail address in the Login Requirement Page, and clicks a button for registering the ID, password, and e-mail of the job seeker/certification candidate. FIG. 2 shows an example of the screen of Interface A1.

Then control system B1 operates to save the information to database D2.

Next, an Entry Form opens. He/she enters résumés, curriculum vitae, etc., in the form, and also enters either of two types of rank, that is, “important” or “optional”, in the prioritized items among the solicited information.

After clicking the Confirmation button to operate control system B1, the Confirmation Page opens to confirm the data.

Then, he/she checks items for résumés and curriculum vitae entered in Server 1 for laying open in web pages, and clicks a button for saving résumés and curriculum vitae.

Accordingly, the data is saved to database D2, and My Page is registered.

Next, in the case of registering personal data, he/she clicks the Register button to open the Login Requirement Page, and enters an ID and password which are different from ones registered when registering the résumés and curriculum vitae mentioned above.

He/she clicks the Save button after entering personal data in the form.

Then, the data is saved to database D1.

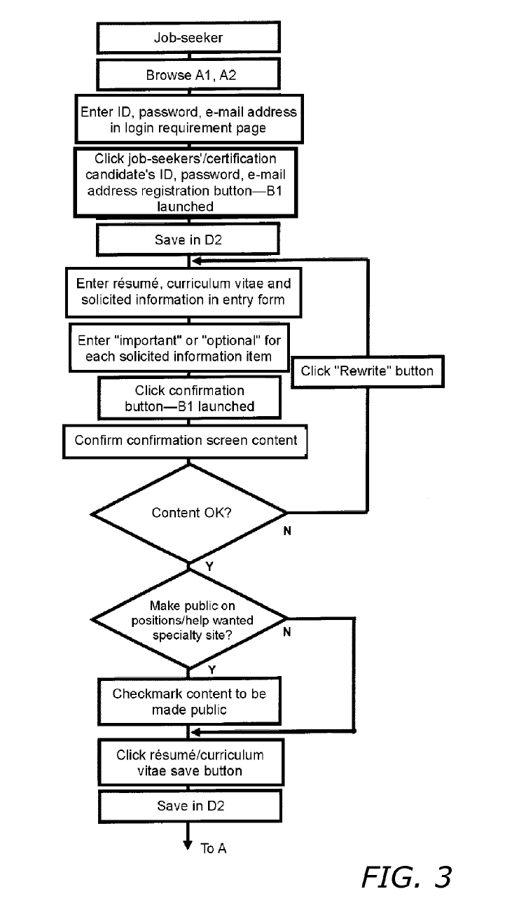

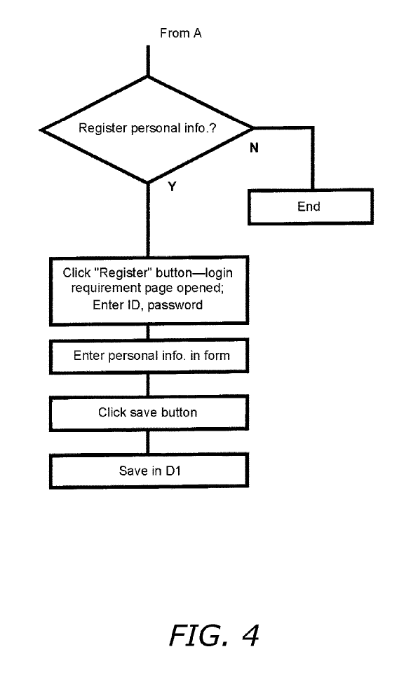

The above procedures for registering résumés and curriculum vitae by job seekers/certification candidates are shown in the flowcharts of FIGS. 3 and 4.

(2) The hiring business accesses Interface A1, browsable by PC, through Network 5 with PCF, and clicks the “For Corporate Client” button.

Then control system B2 operates, and the Membership Form Page opens. The company enters the company's and administrator's data at this page, clicks the Register button for Company's Information to operate control system B2, and then the data are saved to database D3 and database D4, an ID and password are created for each company, and My Page is registered.

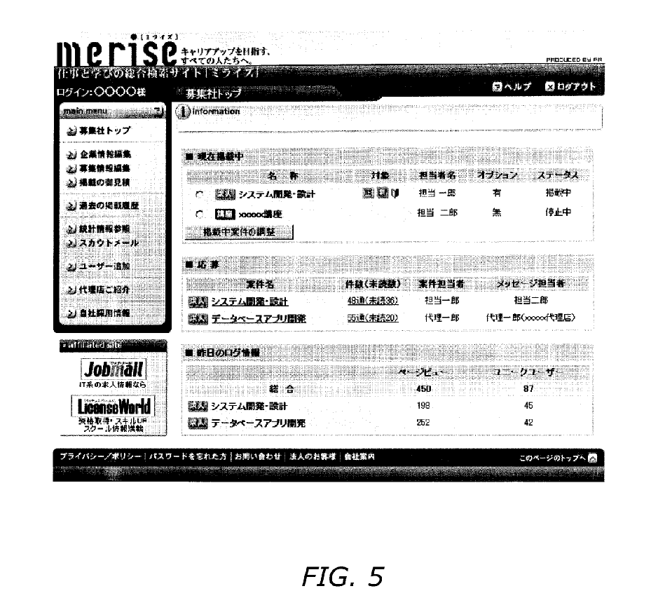

FIG. 5 shows an example of a My Page screen for the hiring business.

The hiring business enters an ID and password already created, and clicks the Login button.

Then, My Page opens. The company enters information about recruitment, seminars, targets, etc., and also enters two types of rank, that is, “important” or “optional”, in the prioritized items among solicited information.

After clicking the Register button for various information to operate control system B2, the information is saved to database D5 and database D6.

Next, the company selects information to provide at Interface 2 and clicks the Decide button.

Then the Frame Purchase Page opens so that the company may select “Insertion by Frame Purchase”, and click the Post in Server 1 button to save the information to database D5 and database D6, and the information is provided at Interface 2 at the same time.

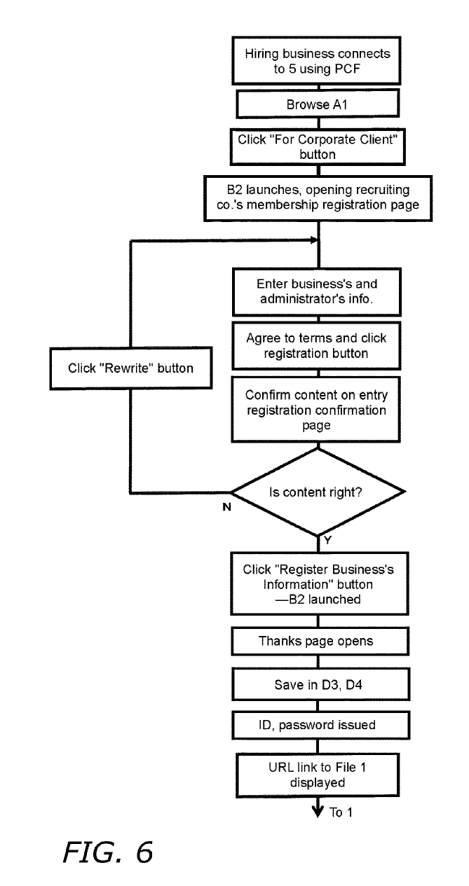

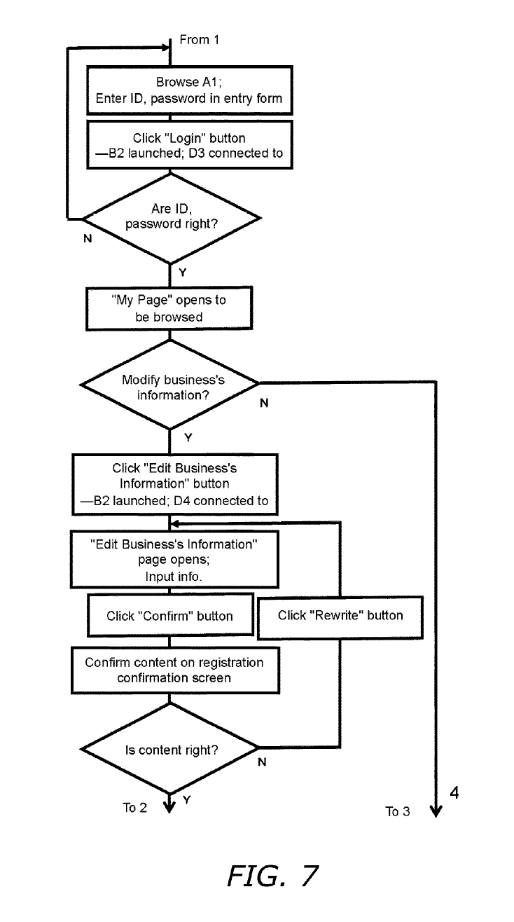

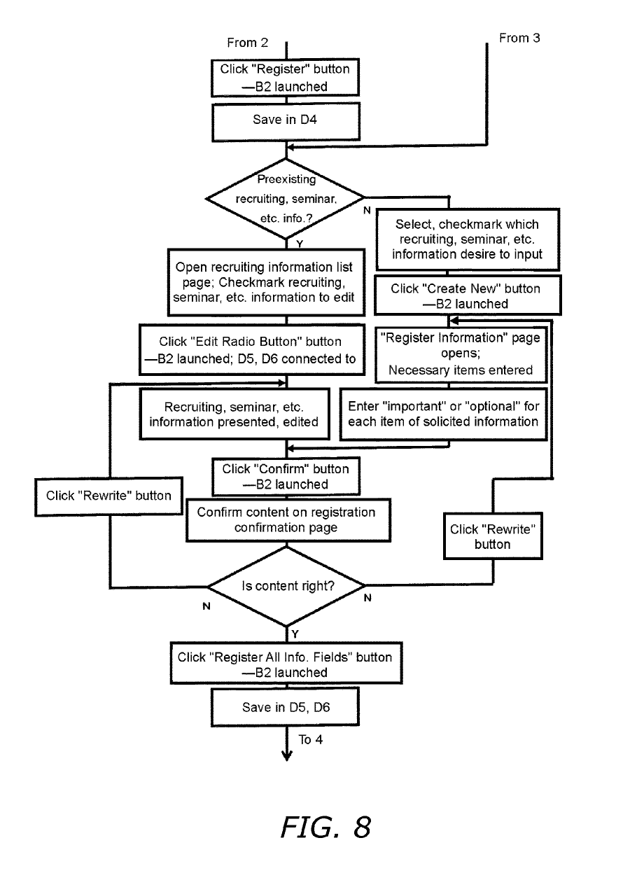

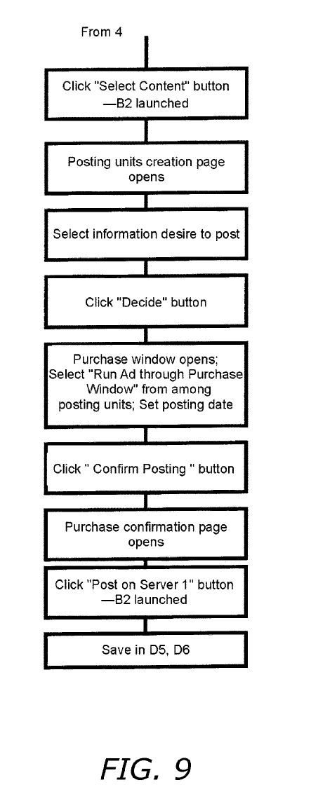

The above procedures for registering information about recruitment and seminar by the hiring business are shown in the flowcharts of FIG. 6, FIG. 7, FIG. 8, and FIG. 9.

(3) The job seeker accesses Interface A1, browsable by PC, or Interface A2, browsable by mobile terminal, of Interface 2 via Network 5 with PCA-D, enters an ID and password, and clicks Login.

Then the control system B10 operates to connect to database D2, database D5, and database D6 so that the job seeker draws his/her own personal data (hereinafter referred to as data 1) from database D2.

(4) Next, the corresponding score table of items designated “important” in the solicited information of data 1 is drawn from score-table database D11. The items designated “important” in the solicited information of data 1 are placed vertically, the corresponding information regarding recruitment and seminars saved in database D5 and database D6 is placed horizontally, and then the figures are matched with scores for “important” items of score-table database D11 (Item Score A).

Next, the corresponding score table of items designated “optional” in the solicited information of data 1 is drawn from score-table database D11. The items designated “optional” in the solicited information of data 1 are placed vertically, the corresponding information regarding recruitment and seminars saved in database D5 and database D6 is placed horizontally, and then the figures are matched with scores for “optional” items of score-table database D11 (Item Score B).

Next, after connecting to weighting database D12, Item Score A designated “important” is multiplied by the percentage of “important” items designated at weighting database D12 (Item Score C).

Item Score B designated “optional” is multiplied by the percentage of “optional” items designated at weighting database D12 (Item Score D).

Score A, as the highest with 100 points, is multiplied by the percentage of “important” items designated at weighting database D12 (Item Score E).

Score B, as the highest with 100 points, is multiplied by percentage of “optional” items designated at weighting database D12 (Item Score F).

Next, final scores are calculated. The sum of Item Score C and Item Score D is divided by the sum of Item Score E and Item Score F.

Scores exceeding N points are searched and the final scores are shown for each set of information in Table 5.

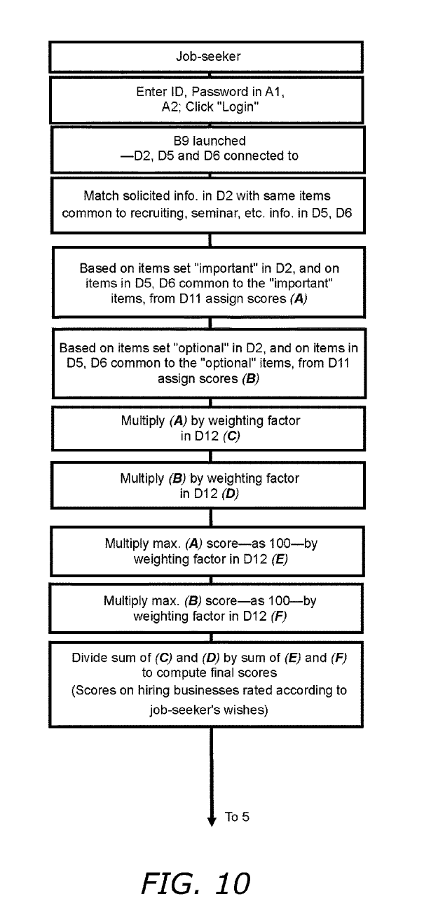

FIG. 10 shows a flowchart of automatically matched information regarding recruitment and seminars desired by the job-seeker and the outputted scores of the hiring business from the standpoint of the job seeker.

(5) The concrete example is as follows.

Information from the job seeker includes résumés and curriculum vitae which present the current status of the job seeker, such as business experience and skills, and solicited information presenting a prospective job desired by the job seeker.

For example, if the person has worked as a programmer and now he/she is thinking of being an SE, the current information is given as a programmer and solicited information is given as an SE.

Based on the information, the job seeker registers the targeted employment occupational category as an important item, specifically as “SE”, and annual income as optional item, specifically as “more than 4 million yen”.

The control system B10 refers to the score table of targeted types of occupation registered as important items in the score-table database D11, ties the employment occupational categories in database D5 together with those in database D6, and gives them scores.

For example, if the employment occupational category in the recruiting information is a programmer, the score is 70.

Next, the score table of targeted annual income, registered as an optional item in score-table database D11, is consulted, and the employment annual incomes in database D5 are tied in with those in database D6 and given scores.

For example, if the annual income in the recruiting information is 4 million yen, the score is 100.

In the case of an amount less than 4 million yen, the score decreases.

For example, in the case of 3.5 million yen, the score is 87; in the case of 3 million yen, the score is 75.

Next, since the desired employment occupational category is registered as an important item, and the desired annual income is registered as an optional item, weighting database D12 is referred to.

If the important item is programmer, the score 70 is multiplied by 100% to make 70. And if the optional item is 4 million yen, the score 100 is multiplied by 50% to make 50.

These points are added, which makes 120. (Score 1)

In order to calculate how the above figure accounts for the highest points, the highest points are calculated as follows.

First, the targeted employment occupational category designated as an important item is assigned the highest points of 100, and then multiplied by the percentage of 100% of the weighting database D12, which makes Score 100.

Next, the targeted annual income designated as an optional item is assigned the highest points of 100, and then multiplied by the percentage of 50% of the weighting database D12, which makes Score 50.

These two figures are added, which makes 150, the highest points.

The above Score 1, 120, is divided by the highest points, 150, and then multiplied by 100, which makes 80, the final score.

The above score is shown by FIG. 21 of Score Table, Table 3.

The final figure is calculated for each set of information to calculate N points, the satisfied points of the job seeker set up by the system administrator. For example, if more than 70 points is a reference mark, then each set of information with more than this number of points is searched, and the final scores are displayed.

(6) Next, for the already searched recruiting information and seminar information (hereinafter referred to as data 2) mentioned above, the corresponding score table of items designated “important” in the solicited information of data 2 is drawn from score-table database D11. The items designated “important” in the solicited information of data 2 are placed vertically, the corresponding items of résumés and curriculum vitae of data 1 are placed horizontally, and then the figures are matched with scores for “important” items of score-table database D11 (Item Score G).

Next, the corresponding score table of items designated “optional” in the solicited information of data 2 is drawn from score-table database D11. The items designated “optional” in the solicited information of data 2 are placed vertically, the corresponding items of résumés and curriculum vitae of data 1 are placed horizontally, and then the figures are matched with scores for “optional” items of score-table database D11 (Item Score H).

Next, after connecting to weighting database D12, Item Score G designated “important” is multiplied by the percentage of “important” items designated at weighting database D12 (Item Score I).

Item Score H designated “optional” is multiplied by the percentage of “optional” items designated at weighting database D12 (Item Score J).

Score G, as the highest with 100 points, is multiplied by the percentage of “important” items designated at weighting database D12 (Item Score K).

Score H, as the highest with 100 points, is multiplied by the percentage of “optional” items designated at weighting database D12 (Item Score L).

Next, final scores are calculated. The sum of Item Score I and Item Score J is divided by the sum of Item Score K and Item Score L.

Then, Table 5 List of information regarding recruitment and courses of FIG. 21 is outputted.

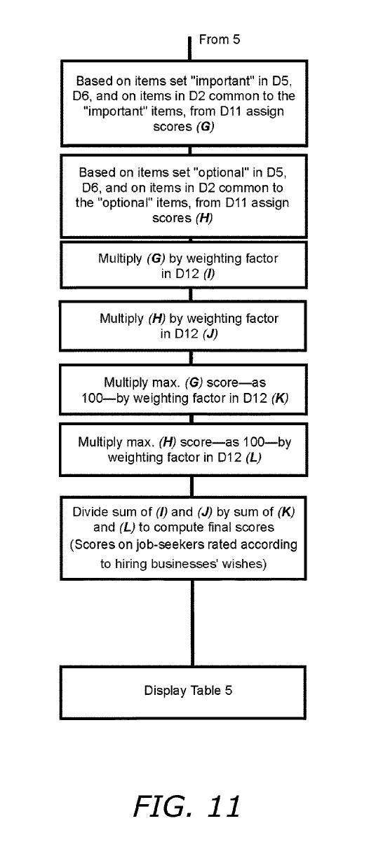

FIG. 11 shows a flowchart of the outputting of job-seeker scores from the standpoint of the hiring business.

### EMBODIMENT 3

Next, Embodiment 3 uses the general system of Embodiment 1. The hiring business registers information regarding recruitment, seminars, and solicited information, and also sets up prioritized ranks of “important” and “optional” to prioritized items among solicited information.

The job seeker registers résumés, curriculum vitae, and solicited information, and also sets up prioritized ranks of “important” and “optional” to prioritized items among solicited information.

The hiring business logs into My Page, and then ties items designated “important” and “optional” in the registered hiring-business-solicited information in with résumé and curriculum vitae items in common with these designated items.

Based on the corresponding items, the score is calculated, and résumés and curriculum vitae with a score exceeding N points are searched and displayed.

In addition, among the searched résumés and curriculum vitae, items designated “important” and “optional” in the solicited information are connected to the corresponding information about recruitment and seminars registered by the hiring business. Based on the corresponding items, the score is calculated and displayed.

In this way, the hiring business's targeted résumés and curriculum vitae are matched automatically, the degree of matching is shown numerically as scores, and the job seeker's targets are shown numerically as scores that shows any discrepancy of between the targets of the job seeker and the demands of the hiring business and thus, supports the nomination procedures for job seekers.

The process is as follows.

(1) The job seeker accesses Interface A1 or Interface A2 Interface 2 of Server 1 via Network 5 with PCA-D, enters an ID, password, and e-mail address in Login Requirement Page, and clicks a button for registering the ID, password, and e-mail of the job seeker/certification candidate.

Then control system B1 operates to save the information to database D2.

Next, the Entry Form opens. He/she enters résumés, curriculum vitae, etc., in the form, and also enters either of two types of rank, that is, “important” or “optional”, in prioritized items among the solicited information.

After clicking the Confirmation button to operate control system B1, the Confirmation Page opens to confirm the data.

Then, he/she checks items of résumés and curriculum vitae entered in Server 1 for laying open in web pages, and clicks a button for saving résumés and curriculum vitae.

Accordingly, the data is saved to database D2, and My Page is registered.

Next, if registering personal data, he/she clicks the Register button to open the Login Requirement Page, and enters an ID and password which are different from the ones registered when registering résumés and curriculum vitae mentioned above.

He/she clicks the Save button after entering personal data in the form. Then, the data is saved to database D1.

The above procedures for registering résumés and curriculum vitae by a job seeker/certification candidate are shown in the flowcharts of FIGS. 3 and 4.

(2) The hiring business accesses Interface A1 through Network 5 with PCF, and clicks the “For Corporate Client” button.

Then control system B2 operates, and the Membership Form Page opens. The company enters the company's and administrator's data at this page, and clicks the Register button for Company's Information to operate control system B2; then the data are saved to database D3 and database D4, an ID and password are created for each company, and My Page is registered.

The hiring business enters an ID and password already created at Interface A1, and clicks the Login button.

Then, My Page opens. The company enters information about recruitment, seminars, targets, etc., and also enters two types of rank, that is, “important” or “optional”, in prioritized items among the solicited information.

After clicking the Register button for various information to operate control system B2, the information is saved to database D5 and database D6.

Next, the company selects information to provide at Interface 2 and clicks the Decide button.

Then the Frame Purchase Page opens so that “Insertion by Frame Purchase” is selected, and the company clicks the Post in Server 1 button to save the information to database D5 and database D6; the information is provided at Interface 2 at the same time.

The above procedures for registering information about recruitment, courses, seminars, and mock examinations by the hiring business are shown in the flowcharts of FIG. 6, FIG. 7, FIG. 8, and FIG. 9.

(3) Next, the hiring business accesses Interface A1 of Server 1 via Network 5 with PCA-D, enters an ID and password, and clicks Login.

Then control system B10 operates to connect to database D2, database D5, and database D6.

The hiring business draws its own company's data (hereinafter referred to as data 3) from database D5 and database D6.

Next, the corresponding score table of items designated “important” in the solicited information of data 3 is drawn from score-table database D11. The items designated “important” in the solicited information of data 3 are placed vertically, the corresponding items of résumés and curriculum vitae saved in database D2 are placed horizontally, and then the figures are matched with scores for “important” items of score-table database D11 (Item Score 1).

Next, the corresponding score table of items designated “optional” in the solicited information of data 3 is drawn from score-table database D11. The items designated “optional” in the solicited information of data 3 are placed vertically, the corresponding items of résumés and curriculum vitae saved in database D2 are placed horizontally, and then the figures are matched with scores for “optional” items of score-table database D11 (Item Score 2).

Next, after connecting to weighting database D12, Item Score 1 designated “important” is multiplied by the percentage of “important” items designated at weighting database D12 (Item Score 3).

Item Score 2 designated “optional” is multiplied by the percentage of “optional” items designated at weighting database D12 (Item Score 4).

Score 1, as the highest with 100 points, is multiplied by the percentage of “important” items designated at weighting database D12 (Item Score 5).

Score 2, as the highest with 100 points, is multiplied by the percentage of “important” items designated at weighting database D12 (Item Score 6).

Next, final scores are calculated. The sum of Item Score 3 and Item Score 4 is divided by the sum of Item Score 5 and Item Score 6.

Scores exceeding N points are searched and the final scores are shown for each set of information in Table 6.

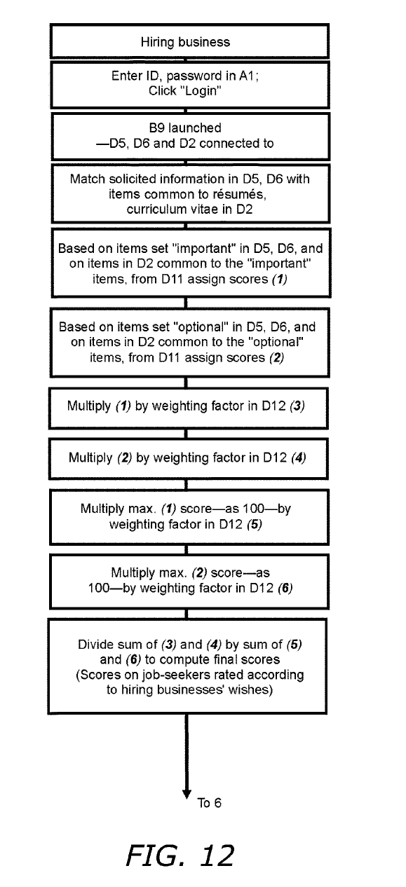

FIG. 12 shows a flowchart of automatically matched résumés and curriculum vitae and the outputting of job-seeker scores from the standpoint of the hiring business.

(4) The concrete example is as follows.

Help-wanted information of the hiring business includes information about recruitment, which presents the current status of the hiring conditions of the hiring business, and in particular, presents solicited information regarding a prospective employee desired by the hiring business.

For example, in the case of recruiting an SE having experience of a programmer, the current information is an SE and the solicited information is a programmer.

Based on the information, the hiring business registers the targeted employment occupational category as an important item, specifically as “SE”, and the years of experience as optional item, specifically as “more than 3 years”.

The control system B10 looks up the Score Table for occupational experience types, registered as an important item, in score-table database D11, and ties it in with occupational experience types in database D2, assigning scores.

For example, if the employment occupational category in job-seeking information is a programmer, the score is 70.

Next, the control system looks up the score table for number of years of experience, registered as an optional item in score-table database D11, and ties it in with the years of experience in database D2, assigning scores.

For example, if the years of experience in the job-seeking information is 3 years, the score is 100.

In the case of less than 3 years, the score decreases.

Next, since the employment occupational category in the recruiting information is registered as an important item, and years of experience is registered as an optional item, the weighting database D12 is referred to.

In the case that the important item is a programmer, score 70 is multiplied by 100% to make 70. And if the optional item is 3 years, score 100 is multiplied by 50% to make 50.

These points are added, which makes 120. (Score 1)

In order to calculate how the above figure accounts for the highest points, the highest points are calculated as follows.

First, the experienced employment occupational category designated as an important item is assigned the highest points of 100, and then multiplied by the percentage of 100% of the weighting database D12, which makes Score 100.

Next, years of experience designated as an optional item is assigned the highest points of 100, and then multiplied by the percentage of 50% of weighting database D12, which makes Score 50.

These two figures are added, which makes 150, the highest points.

The above Score 1, 120, is divided by the highest points, 150, and then multiplied by 100, which makes 80, the final score.

The above score is shown by FIG. 21 of the score table, Table 3.

The final figure is calculated for each set of information to calculate N points, the satisfied points of the hiring business set up by the system administrator or by the hiring business. For example, if more than 70 points is a reference mark, then each set of information greater than 70 points is searched, and the final scores are displayed.

(5) Next, for the already searched information about job-seeking (hereinafter referred to as data 4) mentioned above, the corresponding score table of items designated “important” in the solicited information of data 4 is drawn from score-table database D1. The items designated “important” in the solicited information of data 4 are placed vertically, the corresponding items of the hiring information of data 3 are placed horizontally, and then the figures are matched with scores for “important” items of score-table database D11 (Item Score 7).

Next, the corresponding score table of items designated “optional” in the solicited information of data 4 is drawn from score-table database D11. The items designated “optional” in the solicited information of data 4 are placed vertically, the corresponding items of the hiring information of data 3 are placed horizontally, and then the figures are matched with scores for “optional” items of score-table database D11 (Item Score 8).

Next, after connecting to weighting database D12, Item Score 7 designated “optional” is multiplied by the percentage of “important” items designated at weighting database D12 (Item Score 9).

Item Score 8 designated “optional” is multiplied by the percentage of “optional” items designated at weighting database D12 (Item Score 10).

Score 7, as the highest with 100 points, is multiplied by the percentage of “important” items designated at weighting database D12 (Item Score 11).

Score 8, as the highest with 100 points, is multiplied by the percentage of “optional” items designated at weighting database D12 (Item Score 10).

Next, final scores are calculated. The sum of Item Score 9 and Item Score 10 is divided by the sum of Item Score 11 and Item Score 12.

Then, Table 6 list of job-seeking information is outputted.

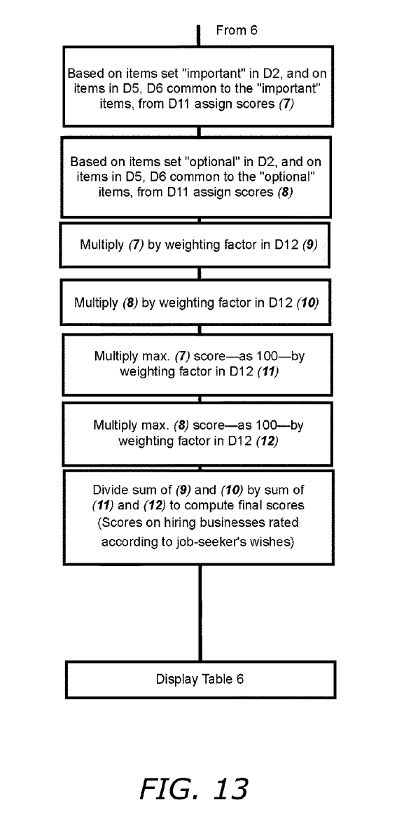

FIG. 13 shows a flowchart of the outputting of hiring-business scores from the standpoint of the job seeker.

### EMBODIMENT 4

Next, Embodiment 4 uses the general system of Embodiment 1. The hiring business registers information regarding recruitment, seminars and solicited information, and also sets up prioritized ranks of “important” and “optional” to prioritized items among the solicited information.

Then control system B7 operates to automatically create a file (File 1) for posting information regarding recruitment, seminars, etc., particular to the various sites, and saves the information to Server 1.

Otherwise the company connects to Server 1 to automatically create a file (File 2) in which a program of providing information regarding recruitment, seminars, etc., is written.

File 1 is linked to various sites, and File 2 is saved to the various sites in order to provide information in the various sites.

After browsing information about recruitment, seminars, etc., provided by various sites, if the job seeker/certification candidate finds the desired information, he/she clicks a button for applying and registering résumés and curriculum vitae, and then enters an ID, password, résumés, curriculum vitae, and solicited information together with his/her personal data optionally, and also sets up a prioritized rank, that is, “important” or “optional”, in prioritized items among the solicited information.

The job seeker ties items designated “important” and “optional” in the registered information solicited by the job seeker/certification candidate in with recruiting information and seminar information in common with these designated items, selected by the job seeker at various sites 6.

Based on the corresponding items, the score is calculated.

Also, to the information about recruitment and seminars selected by the job seeker/certification candidate, items designated “important” and “optional” in the solicited information are connected with the corresponding items of résumés and curriculum vitae registered by the job seeker at various sites 6.

Based on the corresponding items, the score is calculated and displayed.

Next, information provided by Server 1 is matched.

Items designated “important” and “optional” in the registered job-seeker-solicited information/certification candidate are connected with the corresponding information about recruitment and seminars provided by Server 1.

Based on the corresponding items, the score is calculated, and then information about recruitment and seminars with more than N points are searched and displayed.

Also, to the searched information about recruitment and seminars, items designated “important” in the solicited information, and items designated “optional” are connected with the corresponding items of résumés and curriculum vitae of the job seeker/certification candidate. Based on the corresponding items, the score is calculated.

In this way, when the job seeker/certification candidate applies at various sites 6, showing numerically the degree of matching to the hiring business from standpoint of the job seeker and the degree of matching to job seekers from the standpoint of the hiring business shows any discrepancy between the targets of the job seeker and those of the hiring business.

In addition to the hiring businesses browsed, the hiring businesses matched with job seeker are also displayed with scores.

(1) The hiring business accesses Interface A1 through Network 5 with PCF, and clicks the “For Corporate Client” button.

Then control system B2 operates, and the Membership Form Page opens.

At this page, the hiring business enters company's and administrator's data, and clicks the Register button for Company's Information to operate control system B2, and then the data are saved to database D3 and database D4.

After that, an ID and password are created for each company and My Page is registered.

(2) The hiring business enters an ID and password already created at Interface A1, and clicks the Login button.

Then, My Page opens. The hiring business enters information about recruitment, seminars, targets, etc., and clicks the Register button for various information to operate control system B2, and saves the information to database D5 and database D6.

(3) Then control system B7 operates to automatically create a file (File 1) for posting information regarding recruitment, seminars, etc., particular to the various sites, and saves the information to Server 1.

Also, the company connects to Server 1 to automatically create a file (File 2) in which a program of providing information regarding recruitment, seminars, etc., is written.

(4) The following procedures are necessary for the various sites to provide information in the specialized site.

First, in the case of using File 1, after getting the URL to be linked to File 1 from the operating company of Server 1, various sites 6 link the URL with File 1. In the case of using File 2, the file is downloaded to save to the various sites 6.

In this way, information regarding recruitment, seminars, etc., designated as laid-open information can be displayed. As for connecting to Server 1 and providing information, there are various programs that can be used, such as cgi, jsp, asp, html, XML, ActiveX, Java (registered trademark) applet, and Flash.

(5) The job seeker/certification candidate browses various sites 6 with PCA-D, and selects a featured section for information regarding recruitment, seminars, etc., to browse a list of information.

In the case he/she finds desired recruiting information, he/she confirms the data at the detailed page. As a result, in the case he/she applies for the job, he/she clicks a button for applying and registering résumés and curriculum vitae.

After the Login Requirement Page opens, he/she enters an ID, password, and e-mail address in the page.

Then he/she clicks a button for registering the ID, password, and e-mail of the job seeker/certification candidate to save the information to database D2.

(6) Next, the Entry Form opens. He/she enters résumés, curriculum vitae, etc., in the form, and clicks the Confirmation button to save the information database D2.

Next, in the case of registering personal data, he/she clicks the Register button to open the Login Requirement Page, and enters an ID and password which are different from ones registered when registering résumés and curriculum vitae mentioned above.

He/she clicks the Save button after entering personal data in the form. Then, the data is saved to database D1.

(7) Next, control system B10 operates, and then the corresponding score table of items designated “important” and currently registered in the solicited information of the job seeker/certification candidate is drawn from score-table database D11. The items designated “important” and currently registered in the solicited information of the job seeker/certification candidate are placed vertically, the corresponding items of information regarding recruitment, seminars, etc., selected by the job seeker/certification candidate at various sites 6 are placed horizontally, and then the figures are matched with scores for “important” items of score-table database D11 (Item Score A).

Next, the corresponding score table of items designated “optional” and currently registered in the solicited information of the job seeker/certification candidate is drawn from score-table database D11. The items designated “optional” and currently registered in the solicited information of the job seeker/certification candidate are placed vertically, the corresponding information regarding recruitment, seminars, etc., selected by the job seeker/certification candidate at various sites 6 are placed horizontally, and then the figures are matched with scores for “optional” items of score-table database D11 (Item Score B).

Next, after connecting to weighting database D12, Item Score A designated “important” is multiplied by the percentage of “important” items designated at weighting database D12 (Item Score C).

Item Score B designated “optional” is multiplied by the percentage of “optional” items designated at weighting database D12 (Item Score D).

(8) Score A, as the highest with 100 points, is multiplied by the percentage of “important” items designated at weighting database D12 (Item Score E).

Score B, as the highest with 100 points, is multiplied by the percentage of “optional” items designated at weighting database D12 (Item Score F).

Next, final scores are calculated. The sum of Item Score C and Item Score D is divided by the sum of Item Score E and Item Score F.

These figures are displayed in Table 5.

(6) Next, the corresponding score table of items designated “important” in the solicited information of information regarding recruitment, seminars, etc., selected by the job seeker/certification candidate is drawn from score-table database D11. The items designated “important” in the solicited information of information regarding recruitment, seminars, etc., selected by the job seeker/certification candidate are placed vertically, the corresponding items of résumés and curriculum vitae of job seeker/certification candidate registered right now are placed horizontally, and then the figures are matched with scores for “important” items of score-table database D11 (Item Score G).

Next, the corresponding score table of items designated “optional” in the solicited information of information regarding recruitment, seminars, etc., selected by the job seeker/certification candidate is drawn from score-table database D11. The items designated “optional” in the solicited information of information regarding recruitment, seminars, etc., selected by the job seeker/certification candidate are placed vertically, the corresponding items of résumés and curriculum vitae of job seeker/certification candidate currently registered are placed horizontally, and then the figures are matched with scores for “optional” items of score-table database D11 (Item Score H).

Next, after connecting to weighting database D12, Item Score G designated “important” is multiplied by the percentage of “important” items designated at weighting database D12 (Item Score I).

And Item Score H designated “optional” is multiplied by the percentage of “optional” items designated at weighting database D12 (Item Score J).

(10) Score G, as the highest with 100 points, is multiplied by the percentage of “important” items designated at weighting database D12 (Item Score K).

Score H, as the highest with 100 points, is multiplied by the percentage of “optional” items designated at weighting database D12 (Item Score L).

Next, final scores are calculated. The sum of Item Score I and Item Score J is divided by the sum of Item Score K and Item Score L.

The figures are displayed in Table 5.

Then, the job seeker/certification candidate applies for the position.

(11) Next, information about recruitment and seminars provided by Server 1 are matched.

The job seeker/certification candidate clicks the Matching button to other company placed in various sites 6, and then control system B10 operates to connect to database D2, database D5 and database D6 so that the job seeker draws data 1 from database D2.

Next, the corresponding score table of items designated “important” in the solicited information of data 1 is drawn from score-table database D11. The items designated “important” in the solicited information of data 1 are placed vertically, the corresponding information regarding recruitment and seminars saved in database D5 and database D6 are placed horizontally, and then the figures are matched with scores for “important” items of score-table database D11 (Item Score A).

Next, the corresponding score table of items designated “optional” in the solicited information of data 1 is drawn from score-table database D11. The items designated “optional” in the solicited information of data 1 are placed vertically, the corresponding information regarding recruitment and seminars saved in database D5 and database D6 are placed horizontally, and then the figures are matched with scores for “optional” items of score-table database D11 (Item Score B).

Next, after connecting to weighting database D12, Item Score A designated “important” is multiplied by the percentage of “important” items designated at weighting database D12 (Item Score C).

Item Score B designated “optional” is multiplied by the percentage of “optional” items designated at weighting database D12 (Item Score D).

Score A, as the highest with 100 points, is multiplied by the percentage of “important” items designated at weighting database D12 (Item Score E). Score B, as the highest with 100 points, is multiplied by the percentage of “optional” items designated at weighting database D12 (Item Score F).

Next, final scores are calculated. The sum of Item Score C and Item Score D is divided by the sum of Item Score E and Item Score F.

Scores exceeding N points are searched and the final scores are shown for each set of information in Table 5.

The more concrete way of matching and calculating score is the same as described at (5) under Embodiment 2.

(12) Next, for the already searched data 2 mentioned above, the corresponding score table of items designated “important” in the solicited information of data 2 is drawn from score-table database D11. The items designated “important” in the solicited information of data 2 are placed vertically, the corresponding items of résumés and curriculum vitae of data 1 are placed horizontally, and then the figures are matched with scores for “important” items of score-table database D11 (Item Score G).

Next, the corresponding score table of items designated “optional” in the solicited information of data 2 is drawn from score-table database D11. The items designated “optional” in the solicited information of data 2 are placed vertically, the corresponding items of résumés and curriculum vitae of data 1 are placed horizontally, and then the figures are matched with scores for “optional” items of score-table database D11 (Item Score H).

Next, after connecting to weighting database D12, Item Score G designated “important” is multiplied by the percentage of “important” items designated at weighting database D12 (Item Score I).

Item Score H designated “optional” is multiplied by the percentage of “optional” items designated at weighting database D12 (Item Score J).

Score G, as the highest with 100 points, is multiplied by the percentage of “important” items designated at weighting database D12 (Item Score K).

Score H, as the highest with 100 points, is multiplied by the percentage of “optional” items designated at weighting database D12 (Item Score L).

Next, final scores are calculated. The sum of Item Score I and Item Score J is divided by the sum of Item Score K and Item Score L.

These figures are displayed in Table 5.

### EMBODIMENT 5

Next, Embodiment 5 uses the general system of Embodiment 1 and 2. The job seeker registers résumés, curriculum vitae, and solicited information, and also enters priority ranks, that is, “important” or “optional”, in prioritized items among the solicited information.

The hiring business registers information about recruitment and seminars, and also enters priority ranks, that is, “important” or “optional”, in prioritized items among the solicited information.

The job seeker logs into My Page, and then ties items designated “important” and “optional” in the registered information solicited by the job seeker in with recruiting information and seminar information in common with these designated items.

Based on the corresponding items, the score is calculated and information about recruitment and seminars with the score exceeding N points are searched and displayed.

Also, to the searched information about recruitment and seminars, items designated “important” and “optional” in the solicited information are connected with the corresponding items of résumés and curriculum vitae of the job seeker.

Based on the corresponding items, the score is calculated and displayed.

The job seeker can browse information about recruitment, seminars, etc., matched in the way stated above and can apply under his/her own name or under anonymity. Evaluation data of the hiring business providing information regarding recruitment, seminars, etc., from the viewpoint of the job seeker/certification candidate are provided. When the hiring business receives an application from a job seeker, evaluation data of the job seeker/certification candidate from the viewpoint of the hiring business are provided.

The process of one or more interviews, informal decisions, and entrance to the company based on the result are shown. In addition, job seekers who apply for the position anonymously can reveal their real names at any point in the process mentioned above.

The process is as follows.

(1) The job seeker accesses Interface A1 or Interface A2 Interface 2 of Server 1 via Network 5 with PCA-D, enters an ID, password, and e-mail address in the Login Requirement Page, and clicks a button for registering the ID, password, and e-mail of the job seeker/certification candidate.

Then control system B1 operates to save the information to database D2.

Next, the Entry Form opens. He/she enters résumés, curriculum vitae, etc., in the form, and also enters either of two types of rank, that is, “important” or “optional”, in prioritized items among the solicited information.

After clicking the Confirmation button to operate control system B1, the Confirmation Page opens to confirm the data.

Then, he/she checks items of résumés and curriculum vitae entered in Server 1 for laying open in web pages, and clicks a button for saving résumés and curriculum vitae.

Accordingly, the data is saved to database D2, and My Page is registered.

Next, in the case of registering personal data, he/she clicks the Register button to open the Login Requirement Page, and enters an ID and password which are different from ones registered when registering résumés and curriculum vitae mentioned above.

He/she clicks the Save button after entering personal data in the form. Then, the data is saved to database D1.

(2) The hiring business accesses Interface through Network 5 with PCF, and clicks the “For Corporate Client” button.

Then control system B2 operates, and the Membership Form Page opens. The company enters the company's and administrator's data at this page, and clicks the Register button for Company's Information to operate control system B2; then the data are saved to database D3 and database D4, an ID and password are created for each company, and My Page is registered.

The hiring business enters an ID and password already created at Interface A1, and clicks the Login button.

Then, My Page opens. The company enters information about recruitment, seminars, targets, etc., and also enters two types of rank, that is, “important” or “optional”, in prioritized items among the solicited information.

After clicking the Register button of various information to operate control system B2, the information is saved to database D5 and database D6.

Next, the company selects information to provide at Interface 2 and clicks the Decide button.

Then Frame Purchase Page opens so that “Insertion by Frame Purchase” may be selected, and the company clicks the Post in Server 1 button to save the information to database D5 and database D6; the information is provided at Interface 2 at the same time.

(3) The job seeker accesses Interface A1, browsable by PC, or Interface A2, browsable by mobile terminal, of Interface 2 via Network 5 with PCA-D, enters an ID and password, and clicks Login.

Then control system B10 operates to connect to database D2, database D5 and database D6 so that the job seeker draws data 1 from database D2.

Next, the corresponding score table of items designated “important” in the solicited information of data 1 is drawn from score-table database D11. The items designated “important” in the solicited information of data 1 are placed vertically, the corresponding information regarding recruitment and seminars saved in database D5 and database D6 are placed horizontally, and then the figures are matched with scores for “important” items of score-table database D11 (Item Score A).

Next, the corresponding score table of items designated “optional” in the solicited information of data 1 is drawn from score-table database D11. The items designated “optional” in the solicited information of data 1 are placed vertically, the corresponding information regarding recruitment and seminars saved in database D5 and database D6 are placed horizontally, and then the figures are matched with scores for “optional” items of score-table database D11 (Item Score B).

Next, after connecting to weighting database D12, Item Score A designated “important” is multiplied by the percentage of “important” items designated at weighting database D12 (Item Score C).

Item Score B designated “optional” is multiplied by the percentage of “optional” items designated at weighting database D12 (Item Score D).

Score A, as the highest with 100 points, is multiplied by the percentage of “important” items designated at weighting database D12 (Item Score E).

Score B, as the highest with 100 points, is multiplied by the percentage of “optional” items designated at weighting database D12 (Item Score F).

Next, final scores are calculated. The sum of Item Score C and Item Score D is divided by the sum of Item Score E and Item Score F.

Scores exceeding N points are searched and the final scores are shown for each set of information in Table 5.

(4) Next, for the already searched data 2 mentioned above, the corresponding score table of items designated “important” in the solicited information of data 2 is drawn from score-table database D11. The items designated “important” in the solicited information of data 2 are placed vertically, the corresponding items of résumés and curriculum vitae of data 1 are placed horizontally, and then the figures are matched with scores for “important” items of score-table database D11 (Item Score G).

Next, the corresponding score table of items designated “optional” in the solicited information of data 2 is drawn from score-table database D11. The items designated “optional” in the solicited information of data 2 are placed vertically, the corresponding items of résumés and curriculum vitae of data 1 are placed horizontally, and then the figures are matched with scores for “optional” items of score-table database D11 (Item Score H).

Next, after connecting to weighting database D12, Item Score G designated “important” is multiplied by the percentage of “important” items designated at weighting database D12 (Item Score I).

Item Score H designated “optional” is multiplied by the percentage of “optional” items designated at weighting database D12 (Item Score J).

Score G, as the highest with 100 points, is multiplied by the percentage of “important” items designated at weighting database D12 (Item Score K).

Score H, as the highest with 100 points, is multiplied by the percentage of “optional” items designated at weighting database D12 (Item Score L).

Next, final scores are calculated. The sum of Item Score I and Item Score J is divided by the sum of Item Score K and Item Score L.

These figures are displayed in Table 5.

(5) Subsequently, control system B8 operates to connect to database D10.

Next, points of evaluation for each sequence and each status are calculated for each hiring business. As the result, evaluation data of the hiring business for job seekers/certification candidates, Table 1, is outputted.

Subsequently, control system B8 operates to connect to database D10. Next, points of evaluation for each sequence and each status are calculated for each job seeker/certification candidate. As the result, evaluation data for job-seekers/certification candidates for the hiring business, Table 2, is outputted.

(6) The job seeker browses the information regarding recruitment, seminars, etc., that is automatically matched, and when he/she wants to examine evaluation data of the hiring business for job-seekers/certification candidates, he/she clicks the Yes button to display evaluation data of the hiring business for job-seekers/certification candidates, Table 1.

Subsequently, in order to apply, he/she clicks a button for applying and registering résumés and curriculum vitae.

Then he/she connects to the database of résumés, curriculum vitae, and targets of job-seekers/certification candidates D2 to display résumés and curriculum vitae in the Application Page.

After confirming the data, and modifying the data, if needed, the applicant clicks the Confirm button.

(7) In the case of applying anonymously, the applicant selects “Apply (anonymously)”, and clicks the Application button.

Then control system B1 and control system B6 operate to save résumés and curriculum vitae to database D2 and database D7, while at the same time, control system B8 operates to add and save in database D10 one point to “When Application” for the operational sequence and to “Apply (anonymously)” for the operational status.

The calculation is reflected in the evaluation data of the hiring business for job-seekers/certification candidates, Table 1, and in the evaluation data of job-seekers/certification candidates for the hiring business, Table 2.

(8) In the case of applying under his/her real name, the applicant selects “Apply (with name)”, and clicks the Application button.

Then control system B1 and control system B6 operate to save résumés and curriculum vitae to database D2 and database D7, while at the same time control system B8 operates to add and save in database D10 one point to “When Application” for the operational sequence and to “Apply (with name)” for the operational status.

Next, after entering the ID and password for registering personal data, registered personal data opens, and then the applicant confirms the data and clicks the Send button to operate control system B6 to save the personal data to database D7.

The calculation is reflected in the evaluation data of the hiring business for job-seekers/certification candidates, Table 1, and in the evaluation data of job-seekers/certification candidates for the hiring business, Table 2.

The succeeding process leads to the process of applying with names as described later.

(9) The hiring business accesses Interface A1 via Network 5 with PCF, enters an ID and password, and clicks the Login button to open My Page.

Then it clicks the Message button to connect database D7, and examines applications. When it wants to examine evaluation data of job-seekers/certification candidates who applied, it clicks the Yes button to output evaluation data of job-seekers/certification candidates for the hiring business, Table 2.

As the result, when the hiring business wants to give an interview to the applicant, the procedures vary depending on the application submitted by the job-seeker.

(10) First, in the case of an anonymous application by the job seeker/certification candidate, when the hiring business accepts an anonymous interview, it clicks the Reply button and selects “Notice of Interview (anonymity accepted)”.

After clicking Send, control system B6 operates to save the data to database D7, and at the same time control system B8 operates to add and save in database D10 one point to “When reply to Application” for the operational sequence and to “Notice of Interview (anonymity accepted)” for the operational status.

The calculation is reflected in the evaluation data of the hiring business for job-seekers/certification candidates, Table 1, and in the evaluation data of job-seekers/certification candidates for the hiring business, Table 2. In the case of disallowing an anonymous interview, the hiring business clicks the Reply button and selects “Notice of Interview (name required)”.

After clicking Send, control system B6 operates to save the data to database D7, and at the same time control system B8 operates to add and save in database D10 one point to “When reply to Application” for the operational sequence and to “Notice of Interview (name required)” for the operational status.

The calculation is reflected in the evaluation data of the hiring business for job-seekers/certification candidates, Table 1, and in the evaluation data of job-seekers/certification candidates for the hiring business, Table 2.

(11) In the case of rejecting an interview, the hiring business clicks the Reply button and selects “Rejection”. After clicking Send, control system B6 operates to save the data to database D7, and at the same time control system B8 operates to add and save in database D10 one point to “When reply to Application” for the operational sequence and to “Rejection” for the operational status.

The calculation is reflected in the evaluation data of the hiring business for job-seekers/certification candidates, Table 1, and in the evaluation data of job-seekers/certification candidates for the hiring business, Table 2.

(12) The job seeker accesses Interface A1 or Interface A2 of Interface 2 via Network 5 with PCA-D, enters an ID and password in the Enter Form, and clicks the Login button to open My Page.

Then he/she clicks the Message button to connect to database D7 and reads emails sent by the hiring businesses.

(13) If the job seeker receives a reply of “Notice of Interview (anonymity accepted)” and wants to have an interview, he/she clicks the Reply button and selects “Accept Interview (anonymity accepted)”.

After clicking Send, control system B6 operates to save the data to database D7, and at the same time control system B8 operates to add and save in database D10 one point to “Notice of Interview” for the operational sequence and to “Accept Interview (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(14) If the job seeker receives a reply of “Notice of Interview (name required)” and chooses to disclose the personal data, he/she clicks the Reply button and selects “Accept Interview (name accepted)”.

Next, after entering the ID and password for registering personal data, personal data opens, and then the applicant confirms the data and clicks the Send button to operate control system B6 to save the personal data to database D7, and at the same time control system B8 operates to add and save in database D10 one point to “When reply to Notice of Interview” for the operational sequence and to “Accept Interview (name accepted)” for the operational status.

The calculation is reflected in the evaluation data of the hiring business for job-seekers/certification candidates, Table 1, and in the evaluation data of job-seekers/certification candidates for the hiring business, Table 2. The succeeding process leads to the process of applying with name as described later.

(15) If the job seeker receives a reply of “Notice of Interview (anonymity accepted)” and does not want to have the interview, and in case the job seeker/certification candidate receives a reply of “Notice of Interview (name required)” and does not choose to disclose the personal data, he/she clicks the Reply button and selects “Decline Interview”.

After clicking Send, control system B6 operates to save the data to database D7, and at the same time control system B8 operates to add and save in database D10 one point to “When reply to Notice of Interview” for the operational sequence and to “Decline Interview” as status, and saves the information to database D10.

The calculation is reflected in the evaluation data of the hiring business for job-seekers/certification candidates, Table 1, and in the evaluation data of job-seekers/certification candidates for the hiring business, Table 2.

(16) The hiring business accesses Interface A1 via Network 5 with PCF, and enters an ID and password, clicks the Login button to open My Page.

In the case of giving the Nth interview and accepting anonymous interview, the hiring business clicks the Reply button and selects “Notice of Nth Interview (anonymity accepted)”.

After clicking Send, control system B6 operates to save the data to database D7, and at the same time control system B8 operates to add and save in database D10 one point to “Notice of Nth interview” for the operational sequence and to “Notice of Nth interview (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(17) In the case of disallowing an anonymous interview, the hiring business clicks the Reply button and selects “Notice of the Nth Interview (name required)”.

After clicking Send, control system B6 operates to save the data to database D7, and at the same time control system B8 operates to add and save in database D10 one point to “Notice of Nth interview” for the operational sequence and to “Notice of Nth interview (name required) for the operational status.

The calculation is reflected in the evaluation data of the hiring business for job-seekers/certification candidates, Table 1, and the evaluation data of job-seekers/certification candidates for the hiring business, Table 2.

(18) In the case of rejecting without the Nth interview, the hiring business clicks the Reply button and selects “Rejection”.

After clicking Send, control system B6 operates to save the data to database D7, and at the same time control system B8 operates to add and save in database D10 one point to “Notice of Nth interview” for the operational sequence and to “Rejection” for the operational status.

In the case of deciding hiring informally without the Nth interview, the process goes to the procedures for Informal Decision.

This process is described later.

The calculation is reflected in the evaluation data of the hiring business for job-seekers/certification candidates, Table 1, and the evaluation data of job-seekers/certification candidates for the hiring business, Table 2.

(19) The job seeker accesses Interface A1 or Interface A2 of Interface 2 via Network 5 with PCA-D, enters an ID and password in the Enter Form, and clicks the Login button to open My Page.

Then he/she clicks the Message button to connect to database D7 and reads emails sent by the hiring businesses.

(20) If the job seeker receives a reply of “Notice of the Nth Interview (anonymity accepted)” and wants to have an interview, he/she clicks the Reply button and selects “Accept the Nth interview (anonymity accepted)”.

After clicking Send, control system B6 operates to save the data to database D7, and at the same time control system B8 operates to add and save in database D10 one point to “When reply to Notice of the Nth interview” for the operational sequence and to “Accept the Nth interview (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(21) If the job seeker receives a reply of “Notice of the Nth Interview (name required)” and chooses to disclose the personal data, he/she clicks the Reply button and selects “Accept the Nth interview (name accepted)”.

Next, after entering the ID and password for registering personal data, personal data opens, and then the applicant confirms the data and clicks the Send button to operate control system B6 to save the personal data to database D7, and at the same time control system B8 operates to add and save in database D10 one point to “When reply to Notice of the Nth interview” for the operational sequence and to “Accept Nth interview (name accepted)” for the operational status.

The calculation is reflected in the evaluation data of the hiring business for job-seekers/certification candidates, Table 1, and in the evaluation data of job-seekers/certification candidates for the hiring business, Table 2.

The succeeding process leads to the process of applying with a name, described later.

(22) If the job seeker receives a reply of “Notice of the Nth Interview (anonymity accepted)” and does not want to have the interview, and if the job seeker receives a reply of “Notice of the Nth Interview (name required)” and does not choose to disclose the personal data, he/she clicks the Reply button and selects “Decline the Nth interview”.

After clicking Send, control system B6 operates to save the data to database D7, and at the same time control system B8 operates to add and save in database D10 one point to “When reply to Notice of Nth interview” for the operational sequence and to “Decline Nth interview” as status, and saves the information to database D10.

The calculation is reflected in the evaluation data of the hiring business for job-seekers/certification candidates, Table 1, and in the evaluation data of job-seekers/certification candidates for the hiring business, Table 2.

(23) The hiring business accesses Interface A1 via Network 5 with PCF, enters an ID and password, clicks the Login button to open My Page.

In the case of deciding hiring informally and accepting the anonymity, the hiring business clicks the Reply button and selects “Notice of Informal Decision (anonymity accepted)”.

After clicking Send, control system B6 operates to save the data to database D7, and at the same time control system B8 operates to add and save in database D10 one point to “Notice of Informal Decision” for the operational sequence and to “Notice of Informal Decision (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(24) In the case of disallowing the anonymity, the hiring business clicks the Reply button and selects “Notice of Informal Decision (name required)”.

After clicking Send, control system B6 operates to save the data to database D7, and at the same time control system B8 operates to add and save in database D10 one point to “Notice of Informal Decision” for the operational sequence and to “Notice of Informal Decision (name required)” for the operational status.

The calculation is reflected in the evaluation data of the hiring business for job-seekers/certification candidates, Table 1, and in the evaluation data of job-seekers/certification candidates for the hiring business, Table 2.

(25) In the case of disallowing the informal decision, the hiring business clicks the Reply button and selects “Rejection”. After clicking Send, control system B6 operates to save the data to database D7, and at the same time control system B8 operates to add and save in database D10 one point to “Notice of Informal Decision” for the operational sequence and to “Rejection” for the operational status.

The calculation is reflected in the evaluation data of the hiring business for job-seekers/certification candidates, Table 1, and in the evaluation data of job-seekers/certification candidates for the hiring business, Table 2.

(26) The job seeker accesses Interface A1 or Interface A2 via Network 5 with PCA-D, enters an ID and password in the Enter Form, and clicks the Login button to open My Page.

Then he/she clicks the Message button to connect to database D7 and reads emails sent by the hiring businesses.

(27) If the job seeker receives a reply of “Notice of Informal Decision (anonymity accepted)”, and wants to join the company, he/she clicks the Reply button and selects “Accept Informal Decision (anonymity accepted)”.

After clicking Send, control system B6 operates to save the data to database D7, and at the same time control system B8 operates to add and save in database D10 one point to “When reply to Notice of Informal Decision” for the operational sequence and to “Accept Informal Decision (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(28) If the job seeker receives a reply of “Notice of Informal Decision (name required)” and chooses to disclose the personal data, he/she clicks the Reply button and selects “Accept Informal Decision (name required)”.

Next, after entering the ID and password for registering personal data, personal data opens, and then the applicant confirms the data and clicks the Send button to operate control system B6 to save the personal data to database D7, and at the same time control system B8 operates to add and save in database D10 one point to “When reply to Notice of Informal Decision” for the operational sequence and to “Accept Informal Decision (name accepted)” for the operational status.

The calculation is reflected in the evaluation data of the hiring business for job-seekers/certification candidates, Table 1, and in the evaluation data of job-seekers/certification candidates for the hiring business, Table 2.

The succeeding process leads to the process of applying with name described later.

(29) If the job seeker receives a reply of “Notice of Informal Decision (anonymity accepted)” and does not want to join the company, and if the job seeker receives a reply of “Notice of Informal Decision (name required)” and does not choose to disclose the personal data, he/she clicks the Reply button and selects “Decline Informal Decision”.

After clicking Send, control system B6 operates to save the data to database D7, and at the same time control system B8 operates to add and save in database D10 one point to “When reply to Notice of Informal Decision” for the operational sequence and to “Decline Informal Decision” as status, and saves the information to database D10.

The calculation is reflected in the evaluation data of the hiring business for job-seekers/certification candidates, Table 1, and in the evaluation data of job-seekers/certification candidates for the hiring business, Table 2.

(30) The hiring business accesses Interface A1 via Network 5 with PCF, enters an ID and password, and clicks the Login button to open My Page.

In the case of receiving “Notice of Informal Decision (anonymity accepted)”, the hiring business clicks the Reply button and selects “Notice of Appointment (name required)”.

After clicking Send, control system B6 operates to save the data to database D7, and at the same time control system B8 operates to add and save in database D10 one point to “Notice of Appointment” for the operational sequence and to “Notice of Appointment (name required)” for the operational status.

The calculation is reflected in the evaluation data of the hiring business for job-seekers/certification candidates, Table 1, and in the evaluation data of job-seekers/certification candidates for the hiring business, Table 2.

(31) The job seeker accesses Interface A1 or Interface A2 via Network 5 with PCA-D, enters an ID and password in the Enter Form, and clicks the Login button to open My Page.

Then he/she clicks the Message button to connect to database D7 and reads emails sent by the hiring businesses.

(32) If the job seeker receives a reply of “Notice of Appointment (name required)” and chooses to disclose the personal data, he/she clicks the Reply button and selects “Accept Appointment (name accepted)”.

Next, after entering the ID and password for registering personal data, personal data opens, and then the applicant confirms the data and clicks the Send button to operate control system B6 to save the personal data to database D7, and at the same time control system B8 operates to add and save in database D10 one point to “When reply to Notice of Appointment” for the operational sequence and to “Accept Notice of Appointment (name accepted)” for the operational status.

The calculation is reflected in the evaluation data of the hiring business for job-seekers/certification candidates, Table 1, and in the evaluation data of job-seekers/certification candidates for the hiring business, Table 2. Then he/she joins the company.

(33) If the job seeker receives a reply of “Notice of Appointment (name required)” and does not choose to disclose the personal data, he/she clicks the Reply button and selects “Decline Appointment”.

After clicking Send, control system B6 operates to save the data to database D7, and at the same time control system B8 operates to add and save in database D10 one point to “When reply to Notice of Appointment” for the operational sequence and to “Decline Appointment” as status, and saves the information to database D10.

The calculation is reflected in the evaluation data of the hiring business for job-seekers/certification candidates, Table 1, and in the evaluation data of job-seekers/certification candidates for the hiring business, Table 2.

(34) The process of the application with real name is as follows.

The hiring business accesses Interface A1 via Network 5 with PCF, enters an ID and password, and clicks the Login button to open My Page.

Then it clicks the Message button to connect database D7, and examines applications. When it wants to examine evaluation data of job seekers who applied, it clicks the Yes button to output evaluation data of job-seekers/certification candidates for the hiring business Table 2.

As the result, when the hiring business gives an interview to the applicant, it clicks the Reply button and selects “Notice of Interview”.

After clicking Send, control system B6 operates to save the data to database D7, and at the same time control system B8 operates to add and save in database D10 one point to “When reply to Application” for the operational sequence and to “Notice of Interview” for the operational status.

The calculation is reflected in the evaluation data of the hiring business for job-seekers/certification candidates, Table 1, and in the evaluation data of job-seekers/certification candidates for the hiring business, Table 2.

In the case of rejecting an interview, the hiring business clicks the Reply button and selects “Rejection”.

After clicking Send, control system B6 operates to save the data to database D7, and at the same time control system B8 operates to add and save in database D10 one point to “When reply to Application” for the operational sequence and to “Rejection” for the operational status.

The calculation is reflected in the evaluation data of hiring business for job-seekers/certification candidates, Table 1, and in the evaluation data of job-seekers/certification candidates for the hiring business, Table 2.

(35) The job seeker accesses Interface A1 or Interface A2 via Network 5 with PCA-D, enters an ID and password in the Enter Form, and clicks the Login button to open My Page.

Then he/she clicks the Message button to connect to database D7 and reads emails sent by hiring businesses.

(36) If the job seeker receives a reply of “Notice of Interview” and wants to have an interview, he/she clicks the Reply button and selects “Accept Interview”.

After clicking Send, control system B6 operates to save the data to database D7, and at the same time control system B8 operates to add and save in database D10 one point to “When reply to Notice of Interview” for the operational sequence and to “Accept Interview” for the operational status. The calculation is reflected in the evaluation data of the hiring business for job-seekers/certification candidates, Table 1, and in the evaluation data of job-seekers/certification candidates for the hiring business, Table 2.

(37) If the job seeker does not want to have the interview, he/she clicks the Reply button and selects “Decline Interview”.

After clicking Send, control system B6 operates to save the data to database D7, and at the same time control system B8 operates to add and save in database D10 one point to “When reply to Notice of Interview” for the operational sequence and to “Decline Interview” as status, and saves the information to database D10.

The calculation is reflected in the evaluation data of the hiring business for job-seekers/certification candidates, Table 1, and in the evaluation data of job-seekers/certification candidates for the hiring business, Table 2.

(38) The hiring business accesses Interface A1 via Network 5 with PCF, enters an ID and password, and clicks the Login button to open My Page.

In the case of giving the Nth interview, the hiring business clicks the Reply button and selects “Notice of Nth Interview”.

After clicking Send, control system B6 operates to save the data to database D7, and at the same time control system B8 operates to add and save in database D10 one point to “When reply to Notice of Nth interview” for the operational sequence and to “Notice of Nth interview” for the operational status.

The calculation is reflected in the evaluation data of the hiring business for job-seekers/certification candidates, Table 1, and in the evaluation data of job-seekers/certification candidates for the hiring business, Table 2.

(39) In the case of rejecting without the Nth interview, the hiring business clicks the Reply button and selects “Rejection”.

After clicking Send, control system B6 operates to save the data to database D7, and at the same time control system B8 operates to add and save in database D10 one point to “When reply to Notice of Nth interview” for the operational sequence and to “Rejection” for the operational status.

In the case of deciding hiring informally without the Nth interview, the process goes to the procedures for Informal Decision. The calculation is reflected in the evaluation data of the hiring business for job-seekers/certification candidates, Table 1, and in the evaluation data of job-seekers/certification candidates for the hiring business, Table 2.

(40) The job seeker accesses Interface A1 or Interface A2 via Network 5 with PCA-D, enters an ID and password in the Enter Form, and clicks the Login button to open My Page.

Then he/she clicks the Message button to connect to database D7 and reads emails sent by the hiring businesses.

(41) If the job seeker receives a reply of “Notice of the Nth Interview” and wants to have an interview, he/she clicks the Reply button and selects “Accept the Nth interview”.

After clicking Send, control system B6 operates to save the data to database D7, and at the same time control system B8 operates to add and save in database D10 one point to “When reply to Notice of the Nth interview” for the operational sequence and to “Accept the Nth interview” for the operational status.

The calculation is reflected in the evaluation data of the hiring business for job-seekers/certification candidates, Table 1, and in the evaluation data of job-seekers/certification candidates for the hiring business, Table 2.

(42) If the job seeker does not want to have the interview, he/she clicks the Reply button and selects “Decline the Nth interview”.

After clicking Send, control system B6 operates to save the data to database D7, and at the same time control system B8 operates to add and save in database D10 one point to “When reply to Notice of Nth interview” for the operational sequence and to “Decline Nth interview” as status, and saves the information to database D10.

The calculation is reflected in the evaluation data of the hiring business for job-seekers/certification candidates, Table 1, and in the evaluation data of job-seekers/certification candidates for the hiring business, Table 2.

(43) The hiring business accesses Interface A1 via Network 5 with PCF, enters an ID and password, and clicks the Login button to open My Page.

In the case of deciding hiring informally, the hiring business clicks the Reply button and selects “Notice of Informal Decision”.

After clicking Send, control system B6 operates to save the data to database D7, and at the same time control system B8 operates to add and save in database D10 one point to “Notice of Informal Decision” for the operational sequence and to “Notice of Informal Decision” for the operational status.

The calculation is reflected in the evaluation data of the hiring business for job-seekers/certification candidates, Table 1, and in the evaluation data of job-seekers/certification candidates for the hiring business, Table 2.

In the case of disallowing the informal decision, the hiring business clicks the Reply button and selects “Rejection”.

After clicking Send, control system B6 operates to save the data to database D7, and at the same time control system B8 operates to add and save in database D10 one point to “Notice of Informal Decision” for the operational sequence and to “Rejection” for the operational status.

The calculation is reflected in the evaluation data of the hiring business for job-seekers/certification candidates, Table 1, and in the evaluation data of job-seekers/certification candidates for the hiring business, Table 2.

(44) The job seeker accesses Interface A1 or Interface A2 via Network 5 with PCA-D, enters an ID and password in the Enter Form, and clicks the Login button to open My Page.

Then he/she clicks the Message button to connect to database D7 and reads emails sent by the hiring businesses.

(45) If the job seeker receives a reply of “Notice of Informal Decision”, and wants to join the company, he/she clicks the Reply button and selects “Accept Informal Decision”.

After clicking Send, control system B6 operates to save the data to database D7, and at the same time control system B8 operates to add and save in database D10 one point to “When reply to Notice of Informal Decision” for the operational sequence and to “Accept Informal Decision” for the operational status.

The calculation is reflected in the evaluation data of the hiring business for job-seekers/certification candidates, Table 1, and in the evaluation data of job-seekers/certification candidates for the hiring business, Table 2.

(46) If the job seeker does not want to join the company, he/she clicks the Reply button and selects “Decline Informal Decision”.

After clicking Send, control system B6 operates to save the data to database D7, and at the same time control system B8 operates to add and save in database D10 one point to “When reply to Notice of Informal Decision” for the operational sequence and to “Decline Informal Decision” as status, and saves the information to database D10.

The calculation is reflected in the evaluation data of the hiring business for job-seekers/certification candidates, Table 1, and in the evaluation data of job-seekers/certification candidates for the hiring business, Table 2.

(47) The hiring business accesses Interface A1 via Network 5 with PCF, enters an ID and password, and clicks the Login button to open My Page. In the case of receiving “Acceptance of Informal Decision”, the hiring business clicks the Reply button and selects “Notice of Appointment”.

After clicking Send, control system B6 operates to save the data to database D7, and at the same time control system B8 operates to add and save in database D10 one point to “Notice of Appointment” for the operational sequence and to “Notice of Appointment” for the operational status.

The calculation is reflected in the evaluation data of the hiring business for job-seekers/certification candidates, Table 1, and in the evaluation data of job-seekers/certification candidates for the hiring business, Table 2.

(48) The job seeker/certification candidate accesses Interface A1 or Interface A2 via Network 5 with PCA-D, enters an ID and password in the Enter Form, and clicks the Login button to open My Page. Then he/she clicks the Message button to connect to database D7 and reads emails sent by the hiring businesses.

(49) If the job seeker receives a reply of “Notice of Appointment”, he/she clicks the Reply button and selects “Accept Appointment.

After clicking Send, control system B6 operates to save the data to database D7, and at the same time control system B8 operates to add and save in database D10 one point to “When reply to Notice of Appointment” for the operational sequence and to “Accept Notice of Appointment” as status, and saves the information to database D10.

The calculation is reflected in the evaluation data of the hiring business for job-seekers/certification candidates, Table 1, and in the evaluation data of job-seekers/certification candidates for the hiring business, Table 2. Then the applicant joins the company.

These processes are just one example; the name of each status and sequence and the numbers can be changed and increased or decreased.

### EMBODIMENT 6

Next, Embodiment 6 uses the general system of Embodiment 1 and 3. The hiring business registers information about recruitment and seminars, and solicited information, and also enters a priority rank, that is, “important” or “optional”, in prioritized items among the solicited information.

The job seeker registers résumés, curriculum vitae, and solicited information, and also enters prioritized items with plural ranks among the solicited information at the specialized site for information about positions/help wanted, the various sites 6, and the hiring business's own site.

The hiring business logs into My Page, and then ties in items designated “important” and “optional” in the registered hiring-business-solicited information in with recruiting information and seminar information in common with these designated items.

Based on the corresponding items, the score is calculated and résumés and curriculum vitae with a score exceeding N points are searched and displayed.

Furthermore, among the searched résumés and curriculum vitae, items designated “important” and “optional” in the solicited information are connected with the corresponding information about recruitment and seminars registered by the hiring business. Based on the corresponding items, the score is calculated and displayed.

The hiring business can browse résumés and curriculum vitae matched in the way stated above and can make nominations. For the anonymous job-seeker, evaluation data from the viewpoint of the hiring business are provided. When the job seeker receives a nomination from the hiring business, evaluation data of the hiring business from the viewpoint of a certification candidate are provided.

The process of one or more interviews, informal decisions, and entrance to the company based on the result are shown. In addition, a job seeker who received a nomination anonymously can reveal his/her real name at any point in the process.

The process is as follows.

(1) The job seeker accesses Interface A1 or Interface A2 for Server 1 via Network 5 with PCA-D, enters an ID, password, and e-mail address in the Login Requirement Page, and clicks a button for registering the ID, password, and e-mail of the job-seeker.

Then control system B1 operates to save the information to database D2.

Next, an Entry Form opens. He/she enters résumés, curriculum vitae, etc., in the form, and also enters either of two types of rank, that is, “important” or “optional”, in prioritized items among the solicited information.

After clicking the Confirmation button to operate control system B1, a Confirmation Page opens to confirm the data.

Then, he/she checks items of résumés and curriculum vitae entered in Server 1 for laying open in web pages, and clicks a button for saving résumés and curriculum vitae.

Accordingly, the data is saved to database D2, and My Page is registered.

Next, in the case of registering personal data, he/she clicks the Register button to open Login Requirement Page, and enters an ID and password which are different from ones registered when registering résumés and curriculum vitae mentioned above.

He/she clicks the Save button after entering personal data in the form. Then, the data is saved to database D1.

(2) The hiring business accesses Interface A1 through Network 5 with PCF, and clicks the “For Corporate Client” button.

Then control system B2 operates, and a Membership Form Page opens. The company enters company's and administrator's data at this page, and clicks the Register button for Company's Information to operate control system B2; then the data are saved to database D3 and database D4, an ID and password are created for each company, and My Page is registered.

The hiring business enters an ID and password already created at Interface A1, and clicks the Login button.

Then, My Page opens. The company enters information about recruitment, seminars, targets, etc., and also enters two types of rank, that is, “important” or “optional”, in prioritized items among the solicited information.

After clicking the Register button of various information to operate control system B2, the information is saved to database D5 and database D6.

Next, the company selects information to provide at Interface 2 and clicks the Decide button.

Then the Frame Purchase Page opens so that it may select “Insertion by Frame Purchase”, and click the Post in Server 1 button to save the information to database D5 and database D6; the information is provided at Interface 2 at the same time.

(3) Next, the hiring business accesses Interface A1 of Server 1 via Network 5 with PCA-D, enters an ID and password, and clicks Login.

Then control system B10 operates to connect to database D2, database D5 and database D6, and draws data 3 from database D5 and database D6.

(4) Next, the corresponding score table of items designated “important” in the solicited information of data 3 is drawn from score-table database D11. The items designated “important” in the solicited information of data 3 are placed vertically, the corresponding items of résumés and curriculum vitae saved in database D2 are placed horizontally, and then the figures are matched with scores for “important” items of score-table database D11 (Item Score 1).

(5) Next, the corresponding score table of items designated “optional” in the solicited information of data 3 is drawn from score-table database D11. The items designated “optional” in the solicited information of data 3 are placed vertically, the corresponding items of résumés and curriculum vitae saved in database D2 are placed horizontally, and then the figures are matched with scores for “optional” items of score-table database D11 (Item Score 2).

Next, after connecting to weighting database D12, Item Score 1 designated “important” is multiplied by the percentage of “important” items designated at weighting database D12 (Item Score 3).

Item Score 2 designated “optional” is multiplied by the percentage of “optional” items designated at weighting database D12 (Item Score 4).

(6) Score 1, as the highest with 100 points, is multiplied by the percentage of “important” items designated at weighting database D12 (Item Score 5).

Score 2, as the highest with 100 points, is multiplied by the percentage of “important” items designated at weighting database D12 (Item Score 6).

Next, final scores are calculated. The sum of Item Score 3 and Item Score 4 is divided by the sum of Item Score 5 and Item Score 6.

Scores exceeding N points are searched and the final scores are shown for each set of information in Table 6.

(7) Next, for the already searched data 4 mentioned above, the corresponding score table of items designated “important” in the solicited information of data 4 is drawn from score-table database D11. The items designated “important” in the solicited information of data 4 are placed vertically, the corresponding items of the hiring information of data 3 are placed horizontally, and then the figures are matched with scores for “important” items of score-table database D11 (Item Score 7).

(8) Next, the corresponding score table of items designated “optional” in the solicited information of data 4 is drawn from score-table database D11. The items designated “optional” in the solicited information of data 4 are placed vertically, the corresponding items of the hiring information of data 3 are placed horizontally, and then the figures are matched with scores for “optional” items of score-table database D11 (Item Score 8).

Next, after connecting to weighting database D12, Item Score 7 designated “optional” is multiplied by the percentage of “important” items designated at weighting database D12 (Item Score 9).

Item Score 8 designated “optional” is multiplied by the percentage of “optional” items designated at weighting database D12 (Item Score 10).

(9) Score 7, as the highest with 100 points, is multiplied by the percentage of “important” items designated at weighting database D12 (Item Score 11).

Score 8, as the highest with 100 points, is multiplied by the percentage of “optional” items designated at weighting database D12 (Item Score 12).

Next, final scores are calculated. The sum of Item Score 9 and Item Score 10 is divided by the sum of Item Score 11 and Item Score 12.

These figures are displayed in Table 6.

The automatic matching of information about job-seeking is done not only for information registered at the specialized site for information about positions/help wanted, but also for information registered via various sites 6 and the hiring businesses' own sites.

(10) Subsequently, control system B8 operates to connect to database D10.

Next, points of evaluation for each sequence and each status are calculated for each hiring business.

As the result, evaluation data of the hiring business for job-seekers/certification candidates, Table 1, is outputted.

Subsequently, control system B8 operates to connect to database D10.

Next, points of evaluation for each sequence and each status are calculated for each job seeker/certification candidate.

As the result, evaluation data of job-seekers/certification candidates for the hiring business, Table 2, is outputted.

(11) The hiring business browses the automatically matched information of job-seekers/certification candidates, and when the company wants to examine evaluation data of job-seekers/certification candidates for the hiring business, it clicks the Yes button to display evaluation data of job-seekers/certification candidates for the hiring business, Table 2.

As a result, in the case of making a nomination, the procedures vary depending on the necessity of requiring the name of the anonymous job seeker/certification candidate.

If the job seeker/certification candidate process under his/her real name, the succeeding process leads to the process described later.

(12) First, in the case of allowing the anonymity, the hiring business clicks the Reply button and selects “Invitation for Interview (anonymity accepted)”.

After clicking Send, control system B6 operates to save the data to database D7, and at the same time control system B8 operates to add and save in database D10 one point to “When scout” for the operational sequence and to “Invitation for Interview (anonymity accepted)” for the operational status.

The calculation is reflected in the evaluation data of the hiring business for job-seekers/certification candidates, Table 1, and in the evaluation data of job-seekers/certification candidates for the hiring business, Table 2.

In the case of requiring the anonymity, the hiring business clicks the Reply button and selects “Invitation for Interview (name required)”.

After clicking Send, control system B6 operates to save the data to database D7, and at the same time control system B8 operates to add and save in database D10 one point to “When scout” for the operational sequence and to “Invitation for Interview (name required)” for the operational status.

The calculation is reflected in the evaluation data of the hiring business for job-seekers/certification candidates, Table 1, and in the evaluation data of job-seekers/certification candidates for the hiring business, Table 2.

(13) The job seeker/certification candidate accesses Interface A1 or Interface A2 of Interface 2 via Network 5 with PCA-D, enters an ID and password in the Enter Form, and clicks the Login button to open My Page.

Then he/she clicks the Message button to connect to database D7 and reads emails sent by the hiring business.

(14) If the job seeker/certification candidate receives a reply of “Invitation for Interview (anonymity accepted)” and chooses to examine evaluation data of the hiring business for job-seekers/certification candidates, he/she clicks the Yes button to output evaluation data of the hiring business for job-seekers/certification candidates, Table 1.

As the result, in the case of accepting the interview, the applicant clicks the Reply button and selects “Accept Interview (anonymity accepted)”.

After clicking Send, control system B6 operates to save the data to database D7, and at the same time control system B8 operates to add and save in database D10 one point to “When reply to Scout” for the operational sequence and to “Accept Interview (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(15) If the job seeker/certification candidate receives a reply of “Invitation for Interview (name required)” and chooses to examine evaluation data of the hiring business for job-seekers/certification candidates, he/she clicks the Yes button to output evaluation data of the hiring business for job-seekers/certification candidates, Table 1.

As a result, in the case of disclosing personal data, the applicant clicks the Reply button and selects “Accept Interview (name accepted)”.

Next, after entering the ID and password for registering personal data, personal data opens, and then the applicant confirms the data and clicks the Send button to operate control system B6 to save the personal data to database D7, and at the same time control system B8 operates to add and save in database D10 one point to “When reply to Scout” for the operational sequence and to “Accept Interview (name accepted)” for the operational status.

The calculation is reflected in the evaluation data of the hiring business for job-seekers/certification candidates, Table 1, and in the evaluation data of job-seekers/certification candidates for the hiring business, Table 2.

The succeeding process leads to the process of nominating the applicant under his/her real name described later.

(16) If the job seeker/certification candidate receives a reply of “Invitation for Interview (anonymity accepted)” and does not want to have the interview, and if the job seeker/certification candidate receives a reply of “Invitation for Interview (name required)” and does not choose to disclose the personal data, he/she clicks the Reply button and selects “Decline Interview”.

After clicking Send, control system B6 operates to save the data to database D7, and at the same time control system B8 operates to add and save in database D10 one point to “When reply to Scout” for the operational sequence and to “Decline Interview” as status, and saves the information to database D10.

The calculation is reflected in the evaluation data of the hiring business for job-seekers/certification candidates, Table 1, and in the evaluation data of job-seekers/certification candidates for the hiring business, Table 2.

(17) The hiring business accesses Interface A1 via Network 5 with PCF, enters an ID and password, and clicks the Login button to open My Page.

In the case of giving the Nth interview and accepting an anonymous interview, the hiring business clicks the Reply button and selects “Notice of Nth Interview (anonymity accepted)”.

After clicking Send, control system B6 operates to save the data to database D7, and at the same time control system B8 operates to add and save in database D10 one point to “Notice of Nth interview” for the operational sequence and to “Notice of Nth interview (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(18) In the case of disallowing an anonymous interview, the hiring business clicks the Reply button and selects “Notice of the Nth Interview (name required)”.

After clicking Send, control system B6 operates to save the data to database D7, and at the same time control system B8 operates to add and save in database D10 one point to “Notice of Nth interview” for the operational sequence and to “Notice of Nth interview (name required)” for the operational status.

The calculation is reflected in the evaluation data of the hiring business for job-seekers/certification candidates, Table 1, and in the evaluation data of job-seekers/certification candidates for the hiring business, Table 2.

(19) In the case of rejecting without the Nth interview, the hiring business clicks the Reply button and selects “Rejection”.

After clicking Send, control system B6 operates to save the data to database D7, and at the same time control system B8 operates to add and save in database D10 one point to “Notice of Nth interview” for the operational sequence and to “Rejection” for the operational status.

In the case of deciding hiring informally without the Nth interview, the process goes to the procedures for Informal Decision.

This process is described later.

The calculation is reflected in the evaluation data of the hiring business for job-seekers/certification candidates, Table 1, and in the evaluation data of job-seekers/certification candidates for the hiring business, Table 2.

(20) The job seeker/certification candidate accesses Interface A1 or Interface A2 of Interface 2 via Network 5 with PCA-D, enters an ID and password in the Enter Form, and clicks the Login button to open My Page.

Then he/she clicks the Message button to connect to database D7 and reads emails sent by the hiring business.

(21) If the job seeker/certification candidate receives a reply of “Notice of the Nth Interview (anonymity accepted)” and wants to have the Nth interview, he/she clicks the Reply button and selects “Accept the Nth interview (anonymity accepted)”.

After clicking Send, control system B6 operates to save the data to database D7, and at the same time control system B8 operates to add and save in database D10 one point to “When reply to Notice of the Nth interview” for the operational sequence and to “Accept the Nth interview (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(22) If the job seeker/certification candidate receives a reply of “Notice of the Nth Interview (name required)” and chooses to disclose the personal data, he/she clicks the Reply button and selects “Accept the Nth interview (name accepted)”.

Next, after entering the ID and password for registering personal data, personal data opens, and then the applicant confirms the data and clicks the Send button to operate control system B6 to save the personal data to database D7, and at the same time control system B8 operates to add and save in database D10 one point to “When reply to Notice of the Nth interview” for the operational sequence and to “Accept Nth interview (name accepted)” for the operational status.

The calculation is reflected in the evaluation data of the hiring business for job-seekers/certification candidates, Table 1, and in the evaluation data of job-seekers/certification candidates for the hiring business, Table 2. The succeeding process leads to the process of nominating the applicant under his/her real name described later.

(23) If the job seeker/certification candidate receives a reply of “Notice of the Nth Interview (anonymity accepted)” and does not want to have the interview, and if the job seeker/certification candidate receives a reply of “Notice of the Nth Interview (name required)” and does not choose to disclose the personal data, he/she clicks the Reply button and selects “Decline the Nth interview”.

After clicking Send, control system B6 operates to save the data to database D7, and at the same time control system B8 operates to add and save in database D10 one point to “When reply to Notice of Nth interview” for the operational sequence and to “Decline Nth interview” as status, and saves the information to database D10.

The calculation is reflected in the evaluation data of the hiring business for job-seekers/certification candidates, Table 1, and in the evaluation data of job-seekers/certification candidates for the hiring business, Table 2.

(24) The hiring business accesses Interface A1 via Network 5 with PCF, enters an ID and password, and clicks the Login button to open My Page.

In the case of deciding hiring informally and accepting the anonymity, the hiring business clicks the Reply button and selects “Notice of Informal Decision (anonymity accepted)”.

After clicking Send, control system B6 operates to save the data to database D7, and at the same time control system B8 operates to add and save in database D10 one point to “Notice of Informal Decision” for the operational sequence and to “Notice of Informal Decision (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(25) In case of deciding hiring informally and disallowing the anonymity, the hiring business clicks the Reply button and selects “Notice of Informal Decision (name required)”.

After clicking Send, control system B6 operates to save the data to database D7, and at the same time control system B8 operates to add and save in database D10 one point to “Notice of Informal Decision” for the operational sequence and to “Notice of Informal Decision (name required)” for the operational status.

The calculation is reflected in the evaluation data of the hiring business for job-seekers/certification candidates, Table 1, and in the evaluation data of job-seekers/certification candidates for the hiring business, Table 2.

(26) In the case of disallowing the informal decision, the hiring business clicks the Reply button and selects “Rejection”.

After clicking Send, control system B6 operates to save the data to database D7, and at the same time control system B8 operates to add and save in database D10 one point to “Notice of Informal Decision” for the operational sequence and to “Rejection” for the operational status.

The calculation is reflected in the evaluation data of the hiring business for job-seekers/certification candidates, Table 1, and in the evaluation data of job-seekers/certification candidates for the hiring business, Table 2.

(27) The job seeker/certification candidate accesses Interface A1, browsable by PC, or Interface A2, browsable by mobile terminal, of Interface 2 via Network 5 with PCA-D, enters an ID and password in the Enter Form, and clicks the Login button to open My Page.

Then he/she clicks the Message button to connect to database D7 and reads emails sent by the hiring business.

(28) If the job seeker/certification candidate receives a reply of “Notice of Informal Decision (anonymity accepted)”, and wants to join the company, he/she clicks the Reply button and selects “Accept Informal Decision (anonymity accepted)”. After clicking Send, control system B6 operates to save the data to database D7, and at the same time control system B8 operates to add and save in database D10 one point to “When reply to Notice of Informal Decision” for the operational sequence and to “Accept Informal Decision (anonymity accepted)” for the operational status.

The calculation is reflected in the evaluation data of the hiring business for job-seekers/certification candidates, Table 1, and in the evaluation data of job-seekers/certification candidates for the hiring business, Table 2.

(29) If the job seeker/certification candidate receives a reply of “Notice of Informal Decision (name required)” and chooses to disclose the personal data, he/she clicks the Reply button and selects “Accept Informal Decision (name accepted)”.

Next, after entering the ID and password for registering personal data, personal data opens, and then the applicant confirms the data and clicks the Send button to operate control system B6 to save the personal data to database D7, and at the same time control system B8 operates to add and save in database D10 one point to “When reply to Notice of Informal Decision” for the operational sequence and to “Accept Informal Decision (name accepted)” for the operational status.

The calculation is reflected in the evaluation data of the hiring business for job-seekers/certification candidates, Table 1, and in the evaluation data of job-seekers/certification candidates for the hiring business, Table 2. The succeeding process leads to the process of nominating the applicant under his/her real name described later.

(30) If the job seeker/certification candidate receives a reply of “Notice of Informal Decision (anonymity accepted)” and does not want to join the company, and if the job seeker/certification candidate receives a reply of “Notice of Informal Decision (name required)” and does not choose to disclose the personal data, he/she clicks the Reply button and selects “Decline Informal Decision”.

After clicking Send, control system B6 operates to save the data to database D7, and at the same time control system B8 operates to add and save in database D10 one point to “When reply to Notice of Informal Decision” for the operational sequence and to “Decline Informal Decision” as status, and saves the information to database D10.

The calculation is reflected in the evaluation data of the hiring business for job-seekers/certification candidates, Table 1, and in the evaluation data of job-seekers/certification candidates for the hiring business, Table 2.

(31) The hiring business accesses Interface A1 via Network 5 with PCF, enters an ID and password, and clicks the Login button to open My Page.

In the case of receiving “Notice of Informal Decision (anonymity accepted)”, the hiring business clicks the Reply button and selects “Notice of Appointment (name required)”.

After clicking Send, control system B6 operates to save the data to database D7, and at the same time control system B8 operates to add and save in database D10 one point to “Notice of Appointment” for the operational sequence and to “Notice of Appointment (name required)” for the operational status.

The calculation is reflected in the evaluation data of the hiring business for job-seekers/certification candidates, Table 1, and in the evaluation data of job-seekers/certification candidates for the hiring business, Table 2.

(32) The job seeker/certification candidate accesses Interface A1, browsable by PC, or Interface A2, browsable by mobile terminal, of Interface 2 via Network 5 with PCA-D, enters an ID and password in the Enter Form, and clicks the Login button to open My Page. Then he/she clicks the Message button to connect to database D7 and reads emails sent by the hiring business.

(33) If the job seeker/certification candidate receives a reply of “Notice of Appointment (name required)” and chooses to disclose the personal data, he/she clicks the Reply button and selects “Accept Appointment (name required)”.

Next, after entering the ID and password for registering personal data, personal data opens, and then the applicant confirms the data and clicks the Send button to operate control system B6 to save the personal data to database D7, and at the same time control system B8 operates to add and save in database D10 one point to “When reply to Notice of Appointment” for the operational sequence and to “Accept Notice of Appointment (name accepted)” for the operational status.

The calculation is reflected in the evaluation data of the hiring business for job-seekers/certification candidates, Table 1, and in the evaluation data of job-seekers/certification candidates for the hiring business, Table 2. Then he/she joins the company.

(34) If the job seeker/certification candidate receives a reply of “Notice of Appointment (name required)” and does not choose to disclose the personal data, he/she clicks the Reply button and selects “Decline Appointment”.

After clicking Send, control system B6 operates to save the data to database D7, and at the same time control system B8 operates to add and save in database D10 one point to “When reply to Notice of Appointment” for the operational sequence and to “Decline Appointment” as status, and saves the information to database D10.

The calculation is reflected in the evaluation data of the hiring business for job-seekers/certification candidates, Table 1, and in the evaluation data of job-seekers/certification candidates for the hiring business, Table 2.

(35) The process of nominations with real names is as follows.

The hiring business clicks the Reply button and selects “Invitation for Interview”.

After clicking Send, control system B6 operates to save the data to database D7, and at the same time control system B8 operates to add and save in database D10 one point to “When Scout” for the operational sequence and to “Invitation for Interview” for the operational status.

The calculation is reflected in the evaluation data of the hiring business for job-seekers/certification candidates, Table 1, and in the evaluation data of job-seekers/certification candidates for the hiring business, Table 2.

(36) The job seeker/certification candidate accesses Interface A1 or Interface A2 of Interface 2 via Network 5 with PCA-D, enters an ID and password in the Enter Form, and clicks the Login button to open My Page.

Then he/she clicks the Message button to connect to database D7 and reads emails sent by the hiring business.

(37) If the job seeker/certification candidate receives a reply of “Invitation for Interview” and examines evaluation data of the hiring business for job-seekers/certification candidates, he/she clicks the Yes button to output evaluation data of the hiring business for job-seekers/certification candidates Table 1.

As a result, in the case of accepting the interview, the applicant clicks the Reply button and selects “Accept Interview”.

After clicking Send, control system B6 operates to save the data to database D7, and at the same time control system B8 operates to add and save in database D10 one point to “When reply to Scout” for the operational sequence and to “Accept Interview” for the operational status.

The calculation is reflected in the evaluation data of the hiring business for job-seekers/certification candidates, Table 1, and in the evaluation data of job-seekers/certification candidates for the hiring business, Table 2.

(38) If the job seeker/certification candidate does not want to have the interview, he/she clicks the Reply button and selects “Decline Interview”.

After clicking Send, control system B6 operates to save the data to database D7, and at the same time control system B8 operates to add and save in database D10 one point to “When reply to Scout” for the operational sequence and to “Decline Interview” as status, and saves the information to database D10.

The calculation is reflected in the evaluation data of the hiring business for job-seekers/certification candidates, Table 1, and in the evaluation data of job-seekers/certification candidates for the hiring business, Table 2.

(39) The hiring business accesses Interface A1 via Network 5 with PCF, enters an ID and password, and clicks the Login button to open My Page.

In the case of giving the Nth interview, the hiring business clicks the Reply button and selects “Notice of Nth Interview”.

After clicking Send, control system B6 operates to save the data to database D7, and at the same time control system B8 operates to add and save in database D10 one point to “Notice of Nth interview” for the operational sequence and to “Notice of Nth interview” for the operational status.

The calculation is reflected in the evaluation data of the hiring business for job-seekers/certification candidates, Table 1, and in the evaluation data of job-seekers/certification candidates for the hiring business, Table 2.

(40) In the case of rejecting without the Nth interview, the hiring business clicks the Reply button and selects “Rejection”. After clicking Send, control system B6 operates to save the data to database D7, and at the same time control system B8 operates to add and save in database D10 one point to “Notice of Nth interview” for the operational sequence and to “Rejection” for the operational status.

(41) In the case of deciding hiring informally without the Nth interview, the process goes to the procedures for Informal Decision.

The calculation is reflected in the evaluation data of the hiring business for job-seekers/certification candidates, Table 1, and in the evaluation data of job-seekers/certification candidates for the hiring business, Table 2.

(42) The job seeker/certification candidate accesses Interface A1, browsable by PC, or Interface A2, browsable by mobile terminal, of Interface 2 via Network 5 with PCA-D, enters an ID and password in the Enter Form, and clicks the Login button to open My Page.

Then he/she clicks the Message button to connect to database D7 and reads emails sent by the hiring business.

(43) If the job seeker/certification candidate receives a reply of “Notice of the Nth Interview” and wants to have the Nth interview, he/she clicks the Reply button and selects “Accept the Nth interview”.

After clicking Send, control system B6 operates to save the data to database D7, and at the same time control system B8 operates to add and save in database D10 one point to “When reply to Notice of the Nth interview” for the operational sequence and to “Accept the Nth interview” for the operational status.

The calculation is reflected in the evaluation data of the hiring business for job-seekers/certification candidates, Table 1, and in the evaluation data of job-seekers/certification candidates for the hiring business, Table 2.

(44) If the job seeker/certification candidate does not want to have the interview, he/she clicks the Reply button and selects “Decline the Nth interview”.

After clicking Send, control system B6 operates to save the data to database D7, and at the same time control system B8 operates to add and save in database D10 one point to “When reply to Notice of Nth interview” for the operational sequence and to “Decline Nth interview” as status, and saves the information to database D10.

The calculation is reflected in the evaluation data of the hiring business for job-seekers/certification candidates, Table 1, and in the evaluation data of job-seekers/certification candidates for the hiring business, Table 2.

(45) The hiring business accesses Interface A1 via Network 5 with PCF, enters an ID and password, and clicks the Login button to open My Page.

In the case of deciding the hiring hiring informally, the hiring business clicks the Reply button and selects “Notice of Informal Decision”.

After clicking Send, control system B6 operates to save the data to database D7, and at the same time control system B8 operates to add and save in database D10 one point to “Notice of Informal Decision” for the operational sequence and to “Notice of Informal Decision” for the operational status.

The calculation is reflected in the evaluation data of the hiring business for job-seekers/certification candidates, Table 1, and in the evaluation data of job-seekers/certification candidates for the hiring business, Table 2.

(46) In the case of disallowing the informal decision, the hiring business clicks the Reply button and selects “Rejection”.

After clicking Send, control system B6 operates to save the data to database D7, and at the same time control system B8 operates to add and save in database D10 one point to “Notice of Informal Decision” for the operational sequence and to “Rejection” for the operational status.

The calculation is reflected in the evaluation data of the hiring business for job-seekers/certification candidates, Table 1, and in the evaluation data of job-seekers/certification candidates for the hiring business, Table 2.

(47) The job seeker/certification candidate accesses Interface A1 or Interface A2 via Network 5 with PCA-D, enters an ID and password in the Enter Form, and clicks the Login button to open My Page.

Then he/she clicks the Message button to connect to database D7 and reads emails sent by the hiring business.

(48) If the job seeker/certification candidate receives a reply of “Notice of Informal Decision”, and wants to join the company, he/she clicks the Reply button and selects “Accept Informal Decision”.

After clicking Send, control system B6 operates to save the data to database D7, and at the same time control system B8 operates to add and save in database D10 one point to “When reply to Notice of Informal Decision” for the operational sequence and to “Accept Informal Decision” for the operational status.

The calculation is reflected in the evaluation data of the hiring business for job-seekers/certification candidates, Table 1, and in the evaluation data of job-seekers/certification candidates for the hiring business, Table 2.

(49) If the job seeker/certification candidate does not want to join the company, he/she clicks the Reply button and selects “Decline Informal Decision”.

After clicking Send, control system B6 operates to save the data to database D7, and at the same time control system B8 operates to add and save in database D10 one point to “When reply to Notice of Informal Decision” for the operational sequence and to “Decline Informal Decision” as status, and saves the information to database D10.

The calculation is reflected in the evaluation data of the hiring business for job-seekers/certification candidates, Table 1, and in the evaluation data of job-seekers/certification candidates for the hiring business, Table 2.

(50) The hiring business accesses Interface A1 via Network 5 with PCF, enters an ID and password, and clicks the Login button to open My Page.

In the case of receiving “Acceptance of Informal Decision”, the hiring business clicks the Reply button and selects “Notice of Appointment”.

After clicking Send, control system B6 operates to save the data to database D7, and at the same time control system B8 operates to add and save in database D10 one point to “Notice of Appointment” for the operational sequence and to “Notice of Appointment” for the operational status.

The calculation is reflected in the evaluation data of the hiring business for job-seekers/certification candidates, Table 1, and in the evaluation data of job-seekers/certification candidates for the hiring business, Table 2.

(51) The job seeker/certification candidate accesses Interface A1 or Interface A2 via Network 5 with PCA-D, enters an ID and password in the Enter Form, and clicks the Login button to open My Page.

Then he/she clicks the Message button to connect to database D7 and reads emails sent by the hiring business.

(52) If the job seeker/certification candidate receives a reply of “Notice of Appointment”, he/she clicks the Reply button and selects “Accept Appointment”.

After clicking Send, control system B6 operates to save the personal data to database D7, and at the same time control system B8 operates to add and save in database D10 one point to “When reply to Notice of Appointment” for the operational sequence and to “Accept Notice of Appointment” for the operational status.

The calculation is reflected in the evaluation data of the hiring business for job-seekers/certification candidates, Table 1, and in the evaluation data of job-seekers/certification candidates for the hiring business, Table 2. Then he/she joins the company.

These processes are just one example; the name of each status and sequence and the numbers can be changed and increased or decreased.

### EMBODIMENT 7

Next, Embodiment 7 uses the general system of Embodiment 1 and 2. The hiring business registers information regarding recruitment, seminars and solicited information, and also sets up priority ranks of “important” and “optional” to prioritized items among the solicited information.

Then control system B7 operates to automatically create a file (File 1) for posting information regarding recruitment, seminars, etc., particular to the various sites, and saves the information to Server 1.

Alternatively, the company connects to Server 1 to automatically create a file (File 2) in which a program of providing information regarding recruitment, seminars, etc., is written.

File 1 is linked to various sites 6, and File 2 is saved to the various sites in order to provide information in various sites 6.

After browsing information about recruitment, seminars, etc., provided by various sites 6, if the job seeker finds desired information, he/she clicks a résumé/curriculum vitae response and registration button, and then enters an ID, password, résumés, curriculum vitae, and solicited information, together with his/her personal data optionally, and also sets up a prioritized rank, that is, “important” or “optional”, in prioritized items among the solicited information.

The job seeker ties items designated “important” and “optional” in the registered solicited information of job seeker in with recruiting information and seminar information in common with these designated items, selected by the job seeker at various sites 6.

Based on the corresponding items, the score is calculated.

Also, to the information about recruitment and seminars selected by the job seeker, items designated “important” and “optional” in the solicited information are connected with the corresponding items of résumés and curriculum vitae registered by the job seeker at various sites 6.

Based on the corresponding items, the score is calculated.

Based on the score, a job seeker makes a decision to apply, and then applies under his/her name or under anonymity. After one or more interviews, hiring is informally decided, and the applicant joins the company. The process is shown below. In addition, a job seeker who applies for the position anonymously can reveal his/her real name at any point in the process mentioned above.

Next, information provided by Server 1 is matched.

Items designated “important” and “optional” in the registered job-seeker-solicited information/certification candidate are connected with the corresponding information about recruitment and seminars provided by Server 1.

Based on the corresponding items, the score is calculated, and then information about recruitment and seminars with more than N points are searched and displayed.

Also, to the searched information about recruitment and seminars, items designated “important” in the solicited information and items designated “optional” are connected with the corresponding items of résumés and curriculum vitae of the job seeker/certification candidate.

Based on the corresponding items, the score is calculated.

Based on the score, the job seeker makes a decision to apply, and then applies under his/her name or under anonymity. After one or mroe interviews, hiring is informally decided, and the applicant joins the company. The process is shown below. In addition, a job seeker who applies for the position anonymously can reveal his/her real name at any point in the process mentioned above.

The process is as follows.

(1) The hiring business accesses Interface A1 through Network 5 with PCF, and clicks the “For Corporate Client” button. Then control system B2 operates, and the Membership Form Page opens.

At this page, the hiring business enters company's and administrator's data, and clicks the Register button for Company's Information to operate control system B2, and then the data are saved to database D3 and database D4.

After that, an ID and password are created for each company and My Page is registered.

(2) The hiring business enters an ID and password already created at Interface A1, and clicks the Login button.

Then, My Page opens. The hiring business enters information about recruitment, seminars, targets, etc., and clicks the Register button of various information to operate control system B2, and saves the information to database D5 and database D6.

(3) Then control system B7 operates to automatically create a file (File 1) for posting information regarding recruitment, seminars, etc., particular to the various sites, and saves the information to Server 1. The following procedures are necessary for the various sites to provide information in the specialized site.

First, in case of using File 1, after getting the URL to be linked to File 1 from the operating company of Server 1, various sites 6 link the URL with File 1. In the case of using File 2, the file is downloaded to save to the various sites 6.

In this way, information regarding recruitment, seminars, etc., designated as laid-open information can be displayed. As for connecting to Server 1 and providing the information, various programs may be used, such as cgi, jsp, asp, html, XML, ActiveX, Java (registered trademark) applet, and Flash.

(4) The job seeker browses various sites 6 with PCA-D, and selects a featured section for information regarding recruitment, seminars, etc., to browse a list of information. If he/she finds the desired recruiting information, he/she confirms the data at the detailed page.

As the result, if he/she applies for the job, he/she clicks a button for applying and registering résumés and curriculum vitae.

After the Login Requirement Page opens, he/she enters an ID, password, and e-mail address in the page.

Then he/she clicks a button for registering the ID, password, and e-mail of job seeker/certification candidate to save the information to database D2.

Next, the Entry Form opens. He/she enters résumés, curriculum vitae, etc., in the form, and clicks the Confirmation button to save the information database D2.

Next, if registering personal data, he/she clicks the Register button to open Login Requirement Page, and enters an ID and password which are different from ones registered when registering résumés and curriculum vitae mentioned above.

He/she clicks the Save button after entering personal data in the form. Then, the data is saved to database D1.

(5) Next, control system B10 operates, and then the corresponding score table of items designated “important” and currently registered in the solicited information of the job seeker is drawn from score-table database D11. The items designated “important” and currently registered in the solicited information of the job seeker are placed vertically, the corresponding information regarding recruitment, seminars, etc., selected by the job seeker/certification candidate at various sites 6 are placed horizontally, and then the figures are matched with scores for “important” items of score-table database D11 (Item Score A).

(6) Next, the corresponding score table of items designated “optional” and currently registered in the solicited information of the job seeker is drawn from score-table database D11. The items designated “optional” registered right now in the solicited information of job seeker are placed vertically, the corresponding information regarding recruitment, seminars, etc., selected by the job seeker at various sites 6 are placed horizontally, and then the figures are matched with scores for “optional” items of score-table database D11 (Item Score B).

Next, after connecting to weighting database D12, Item Score A designated “important” is multiplied by the percentage of “important” items designated at weighting database D12 (Item Score C). Item Score B designated “optional” is multiplied by the percentage of “optional” items designated at weighting database D12 (Item Score D).

(7) Score A, as the highest with 100 points, is multiplied by the percentage of “important” items designated at weighting database D12 (Item Score E).

Score B, as the highest with 100 points, is multiplied by the percentage of “optional” items designated at weighting database D12 (Item Score F).

Next, final scores are calculated. The sum of Item Score C and Item Score D is divided by the sum of Item Score E and Item Score F.

These figures are displayed in Table 5.

(8) Next, the corresponding score table of items designated “important” in the solicited information of information regarding recruitment, seminars, etc., selected by the job seeker is drawn from score-table database D11. The items designated “important” in the solicited information of information regarding recruitment, seminars, etc., selected by the job seeker are placed vertically, the corresponding items of résumés and curriculum vitae of job seeker/certification candidate registered right now are placed horizontally, and then the figures are matched with scores for “important” items of score-table database D11 (Item Score G).

(9) Next, the corresponding score table of items designated “optional” in the solicited information of information regarding recruitment, seminars, etc., selected by the job seeker is drawn from score-table database D11. The items designated “optional” in the solicited information of information regarding recruitment, seminars, etc., selected by the job seeker are placed vertically, the corresponding items of résumés and curriculum vitae of job seeker/certification candidate registered right now are placed horizontally, and then the figures are matched with scores for “optional” items of score-table database D11 (Item Score H).

(10) Next, after connecting to weighting database D12, Item Score G designated “important” is multiplied by the percentage of “important” items designated at weighting database D12 (Item Score I). Item Score H designated “optional” is multiplied by the percentage of “optional” items designated at weighting database D12 (Item Score J).

(11) Score G, as the highest with 100 points, is multiplied by the percentage of “important” items designated at weighting database D12 (Item Score K). Score H, as the highest with 100 points, is multiplied by the percentage of “optional” items designated at weighting database D12 (Item Score L).

(12) Next, final scores are calculated. The sum of Item Score I and Item Score J is divided by the sum of Item Score K and Item Score L.

The figures are displayed in Table 5.

Then, job seeker browses Table 5 and applies using the system described later.

The process of applying is the same as that described at (5) through (49) under Embodiment 5.

(13) Next, information about recruitment and seminars provided by Server 1 are matched.

The job seeker clicks the Matching button to other companies placed in various sites 6, and then control system B10 operates to connect to database D2, database D5 and database D6 so that the job seeker draws data 1 from database D2.

(14) Next, the corresponding score table of items designated “important” in the solicited information of data 1 is drawn from score-table database D11. The items designated “important” in the solicited information of data 1 are placed vertically, the corresponding information regarding recruitment and seminars saved in database D5 and database D6 are placed horizontally, and then the figures are matched with scores for “important” items of score-table database D11 (Item Score A).

(15) Next, the corresponding score table of items designated “optional” in the solicited information of data 1 is drawn from score-table database D11. The items designated “optional” in the solicited information of data 1 are placed vertically, the corresponding information regarding recruitment and seminars saved in database D5 and database D6 are placed horizontally, and then the figures are matched with scores for “optional” items of score-table database D11 (Item Score B).

(16) Next, after connecting to weighting database D12, Item Score A designated “important” is multiplied by the percentage of “important” items designated at weighting database D12 (Item Score C).

Item Score B designated “optional” is multiplied by the percentage of “optional” items designated at weighting database D12 (Item Score D).

(17) Score A, as the highest with 100 points, is multiplied by the percentage of “important” items designated at weighting database D12 (Item Score E).

Score B, as the highest with 100 points, is multiplied by the percentage of “optional” items designated at weighting database D12 (Item Score F).

(18) Next, final scores are calculated. The sum of Item Score C and Item Score D is divided by the sum of Item Score E and Item Score F.

Scores exceeding N points are searched and the final scores are shown for each set of information in Table 5.

(19) Next, for the already searched data 2 mentioned above, the corresponding score table of items designated “important” in the solicited information of data 2 is drawn from score-table database D11. The items designated “important” in the solicited information of data 2 are placed vertically, the corresponding items of résumés and curriculum vitae of data 1 are placed horizontally, and then the figures are matched with scores for “important” items of score-table database D11 (Item Score G).

(20) Next, the corresponding score table of items designated “optional” in the solicited information of data 2 is drawn from score-table database D11. The items designated “optional” in the solicited information of data 2 are placed vertically, the corresponding items of résumés and curriculum vitae of data 1 are placed horizontally, and then the figures are matched with scores for “optional” items of score-table database D11 (Item Score H).

(21) Next, after connecting to weighting database D12, Item Score G designated “important” is multiplied by the percentage of “important” items designated at weighting database D12 (Item Score I).

Item Score H designated “optional” is multiplied by the percentage of “optional” items designated at weighting database D12 (Item Score J).

(22) Score G, as the highest with 100 points, is multiplied by the percentage of “important” items designated at weighting database D12 (Item Score K).

Score H, as the highest with 100 points, is multiplied by the percentage of “optional” items designated at weighting database D12 (Item Score L).

(23) Next, final scores are calculated. The sum of Item Score I and Item Score J is divided by the sum of Item Score K and Item Score L.

(24) These figures are displayed in Table 5. The job seeker browses Table 5, and makes applications under his/her name or under anonymity.

The process of applying is the same as that described at (5) through (49) under Embodiment 5.

### EMBODIMENT 8

Next, Embodiment 8 uses the general system of Embodiment 1 and 2. The hiring business accesses Interface A1 via Network 5 and registers information regarding recruitment, seminars and solicited information, and also sets up priority ranks of “important” and “optional” to prioritized items among the solicited information.

By selecting information to be posted at the own site of the company, and clicking the Posting button to Own Site placed at Interface A1, the page generator for the hiring business's own site B8 operates to automatically create a file (File 1) for posting information regarding recruitment, seminars, etc., particular to the hiring business's own site, and saves it to Server 1.

Otherwise the company connects to Server 1 to automatically create a file (File 2) in which a program of providing information regarding recruitment, seminars, etc., is written.

File 1 is linked to the hiring business's own site S5, and File 2 is saved to the hiring business's own site S5 in order to provide information in the hiring business's own site S5.

After browsing information about recruitment, seminars, etc., provided by the hiring business's own site S5, if job seeker finds the desired information, he/she clicks a button for applying and registering résumés and curriculum vitae, and then enters an ID, password, résumés, curriculum vitae, and solicited information, together with his/her personal data optionally, and also sets up a prioritized rank, that is, “important” or “optional”, in the prioritized items among the solicited information.

The job seeker ties items designated “important” and “optional” in the registered job-seeker-solicited information in with recruiting information and seminar information in common with these designated items, selected by the job seeker at the hiring business's own site S5.

Based on the corresponding items, the score is calculated.

Also, to the information about recruitment and seminars selected by the -seeker, items designated “important” and “optional” in the solicited information are connected with the corresponding items of résumés and curriculum vitae registered by the job seeker at the hiring business's own site S5.

Based on the corresponding items, the score is calculated.

Based on the score, the job seeker makes a decision to apply, and then applies under his/her name or under anonymity. After one or more interviews, hiring is informally decided, and the applicant joins the company. The process is shown below. In addition, a job seeker who applies for the position anonymously can reveal his/her real name at any point in the process mentioned above.

Next, information provided by Server 1 is matched.

The job seeker clicks the Matching button to other company placed in File 1 linked to the hiring business's own S5 or File 2 saved in the site. Then items designated “important” and “optional” in the registered solicited information of job seeker are connected with the corresponding information about recruitment and seminars provided by Server 1.

Based on the corresponding items, the score is calculated, and then information about recruitment and seminars with more than N points are searched and displayed.

Also, to the searched information about recruitment and seminars, items designated “important” in the solicited information, and items designated “optional” are connected with the corresponding items of résumés and curriculum vitae of the job-seeker.

Based on the corresponding items, the score is calculated. Based on the score, the job seeker makes a decision to apply, and then applies under his/her name or under anonymity. After one or more interviews, hiring is informally decided, and the applicant joins the company. The process is shown below. In addition, a job seeker who applies for the position anonymously can reveal his/her real name at any point in the process mentioned above.

The process is as follows.

(1) The hiring business accesses Interface A1 through Network 5 with PCF, and clicks the “For Corporate Client” button. Then control system B2 operates, and the Membership Form Page opens.

At this page, the hiring business enters the company's and administrator's data, and clicks the Register button for Company's Information to operate control system B2, and then the data are saved to database D3 and database D4.

After that, an ID and password are created for each company and My Page is registered.

Also, the URL linked to a file (File 1) mentioned later for providing information about recruitment, seminars, etc., of the particular hiring business is displayed. The URL linked to the file may be displayed after creating File 1 and File 2 mentioned later.

(2) The hiring business enters an ID and password already created at Interface A1, and clicks the Login button.

Then, My Page opens. The hiring business enters information about recruitment, seminars, targets, etc., and clicks the Register button of various information to operate control system B2, and saves the information to database D5 and database D6.

(3) In the case of providing information at its hiring business's own site, the company selects information about recruitment, seminars, etc., for posting at its own site at the above mentioned My Page, and selects the Posting at Own Site at Frame Purchase Page.

Next, if there are any particular formats or designed pages, they are saved to Server 1. The unique page for the hiring business's own site may be created not only by the company itself, but also by a professional designer.

Then, the hiring business clicks a button for posting at hiring business's own site to operate control system B3, and the data are saved to database D5 and database D6.

At the same time, the page generator for the hiring business's own site B8 operates to automatically create a file (File 1) for posting information regarding recruitment, courses, seminars, mock exams, etc., particular to the hiring business, and saves it to Server 1.

It connects to Server 1 to automatically create a file (File 2) in which a program of providing information regarding recruitment, courses, seminars, mock exams, etc., is written.

If File 1 is used, the URL linked to File 1 displayed when creating the ID and password of the hiring business is linked to the desired page of the hiring business's own site to post the information.

If File 2 is used, the page is downloaded to be saved to the server of the hiring business's own site.

As stated above, information regarding recruitment, courses, seminars, mock exams, etc., designated as open information is displayed. There are a variety of programs for connecting to Server 1 and providing information, such as cgi, jsp, asp, html, XML, ActiveX, Java (registered trademark) applet, Flash.

(4) The job seeker browses the hiring business's own site S5 with PCA-D, and selects a featured section for information regarding recruitment, seminars, etc., to browse a list of information. If he/she finds the desired recruiting information, he/she confirms the data at the detailed page.

As a result, if he/she applies for the job, he/she clicks a button for applying and registering résumés and curriculum vitae.

After the Login Requirement Page opens, he/she enters an ID, password, and e-mail address in the page.

Then he/she clicks a button for registering the ID, password, and e-mail of job seeker/certification candidate to save the information to database D2.

Next, the Entry Form opens. He/she enters résumés, curriculum vitae, etc., in the form, and clicks the Confirmation button to save the information database D2.

Next, if registering personal data, he/she clicks the Register button to open the Login Requirement Page, and enters an ID and password which are different from ones registered when registering résumés and curriculum vitae mentioned above.

He/she clicks the Save button after entering personal data in the form. Then, the data is saved to database D1.

(5) Next, control system B10 operates, and then the corresponding score table of items designated “important” and currently registered in the solicited information of the job seeker is drawn from score-table database D11. The items designated “important” and currently registered in the solicited information of the job seeker are placed vertically, the corresponding information regarding recruitment, seminars, etc., selected by the job seeker at the hiring business's own site of the hiring business S5 are placed horizontally, and then the figures are matched with scores for “important” items of score-table database D11 (Item Score A).

(6) Next, the corresponding score table of items designated “optional” and currently registered in the solicited information of the job seeker is drawn from score-table database D11. The items designated “optional” and currently registered in the solicited information of the job seeker are placed vertically, the corresponding information regarding recruitment, seminars, etc., selected by the job seeker at the hiring business's own site S5 are placed horizontally, and then the figures are matched with scores for “optional” items of score-table database D11 (Item Score B).

Next, after connecting to weighting database D12, Item Score A designated “important” is multiplied by the percentage of “important” items designated at weighting database D12 (Item Score C). Item Score B designated “optional” is multiplied by the percentage of “optional” items designated at weighting database D12 (Item Score D).

(7) Score A, as the highest with 100 points, is multiplied by the percentage of “important” items designated at weighting database D12 (Item Score E).

Score B, as the highest with 100 points, is multiplied by the percentage of “optional” items designated at weighting database D12 (Item Score F).

Next, final scores are calculated. The sum of Item Score C and Item Score D is divided by the sum of Item Score E and Item Score F.

These figures are displayed in Table 5.

(8) Next, the corresponding score table of items designated “important” in the solicited information regarding recruitment, seminars, etc., selected by the job seeker is drawn from score-table database D11. The items designated “important” in the solicited information regarding recruitment, seminars, etc., selected by the job seeker are placed vertically, the corresponding items of résumés and curriculum vitae of the job seeker that are currently registered are placed horizontally, and then the figures are matched with scores for “important” items of score-table database D11 (Item Score G).

(9) Next, the corresponding score table of items designated “optional” in the solicited information of information regarding recruitment, seminars, etc., selected by the job seeker is drawn from score-table database D11. The items designated “optional” in the solicited information of information regarding recruitment, seminars, etc., selected by the job seeker are placed vertically, the corresponding items of résumés and curriculum vitae of the job seeker that are currently registered are placed horizontally, and then the figures are matched with scores for “optional” items of score-table database D11 (Item Score H).

(10) Next, after connecting to weighting database D12, Item Score G designated “important” is multiplied by the percentage of “important” items designated at weighting database D12 (Item Score I). Item Score H designated “optional” is multiplied by the percentage of optional items designated at weighting database D12 (Item Score J).

(11) Score G, as the highest with 100 points, is multiplied by the percentage of important items designated at weighting database D12 (Item Score K). Score H, as the highest with 100 points, is multiplied by the percentage of optional items designated at weighting database D12 (Item Score L).

(12) Next, final scores are calculated. The sum of Item Score I and Item Score J is divided by the sum of Item Score K and Item Score L.

The figures are displayed in Table 5.

Then, job seeker browses Table 5 and applies using the system described later. The application process is same as that described at (5) through (49) under Embodiment 5.

(13) Next, information about recruitment and seminars provided by Server 1 are matched.

The job seeker clicks the Matching button to other companies placed in File 1 that are linked to the hiring business's own site or File 2 saved in the hiring business's own site, and then control system B10 operates to connect to database D2, database D5 and database D6 so that the job seeker draws data 1 from database D2.

(14) Next, the corresponding score table of items designated “important” in the solicited information of data 1 is drawn from score-table database D11. The items designated “important” in the solicited information of data 1 are placed vertically, the corresponding information regarding recruitment and seminars saved in database D5 and database D6 are placed horizontally, and then the figures are matched with scores for “important” items of score-table database D11 (Item Score A).

(15) Next, the corresponding score table of items designated “optional” in the solicited information of data 1 is drawn from score-table database D11. The items designated “optional” in the solicited information of data 1 are placed vertically, the corresponding information regarding recruitment and seminars saved in database D5 and database D6 are placed horizontally, and then the figures are matched with scores for “optional” items of score-table database D11 (Item Score B).

(16) Next, after connecting to weighting database D12, Item Score A designated “important” is multiplied by the percentage of “important” items designated at weighting database D12 (Item Score C).

Item Score B designated “optional” is multiplied by the percentage of “optional” items designated at weighting database D12 (Item Score D).

(17) Score A, as the highest with 100 points, is multiplied by the percentage of “important” items designated at weighting database D12 (Item Score E).

Score B, as the highest with 100 points, is multiplied by the percentage of “optional” items designated at weighting database D12 (Item Score F).

(18) Next, final scores are calculated. The sum of Item Score C and Item Score D is divided by the sum of Item Score E and Item Score F.

Scores exceeding N points are searched and the final scores are shown for each set of information in Table 5.

(19) Next, for the already searched data 2 mentioned above, the corresponding score table of items designated “important” in the solicited information of data 2 is drawn from score-table database D11. The items designated “important” in the solicited information of data 2 are placed vertically, the corresponding items of résumés and curriculum vitae of data 1 are placed horizontally, and then the figures are matched with scores for “important” items of score-table database D11 (Item Score G).

(20) Next, the corresponding score table of items designated “optional” in the solicited information of data 2 is drawn from score-table database D11. The items designated “optional” in the solicited information of data 2 are placed vertically, the corresponding items of résumés and curriculum vitae of data 1 are placed horizontally, and then the figures are matched with scores for “optional” items of score-table database D11 (Item Score H).

(21) Next, after connecting to weighting database D12, Item Score G designated “important” is multiplied by the percentage of “important” items designated at weighting database D12 (Item Score I).

Item Score H designated “optional” is multiplied by the percentage of “optional” items designated at weighting database D12 (Item Score J).

(22) Score G, as the highest with 100 points, is multiplied by the percentage of “important” items designated at weighting database D12 (Item Score K).

Score H, as the highest with 100 points, is multiplied by the percentage of “optional” items designated at weighting database D12 (Item Score L).

(23) Next, final scores are calculated. The sum of Item Score I and Item Score J is divided by the sum of Item Score K and Item Score L.

(24) These figures are displayed in Table 5. The job seeker browses Table 5, and applies under his/her name or under anonymity.

The application process is same as that described at (5) through (49) under Embodiment 5.

### INDUSTRIAL APPLICABILITY

The matching system for information about positions/help wanted through the network system of the present invention enables:
A. job seekers to
(1) apply, request brochures, etc., under anonymity;
(2) figure out how many job offers the hiring business is offering by being provided evaluation data, including the numbers of interviews, informal decisions, appointments, and nominations done by the hiring business;
(3) apply, request brochures, and apply for courses without worrying about leaks of personal data because there are two different databases, one of personal data and one of résumés and curriculum vitae;
(4) by showing numerically the degree of matching between the target of job seeker and the hiring conditions of the hiring business, and at the same time showing numerically the degree of matching between the target of the hiring business and experience and skills of job seeker, figure out the expected degree of matching of the job seeker and the hiring business, eliminate mismatched applications, and get fewer mismatched nominations from the hiring business; and
(5) get highly detailed help-wanted information and more matched nominations that lead to more efficient job-seeking activities, and that also have a strong probability of success for joining the company;
B. hiring businesses to
(6) figure out whether the job seeker really exists and whether the registered data are correct by being provided evaluation data, including the numbers of applications, interviews, informal decisions, appointments, and nominations given to the job-seeker;
(7) by showing numerically the degree of matching between the target of the job seeker and the hiring conditions of the hiring business, and at the same time showing numerically the degree of matching between the target of the hiring business and the experience and skills of the job seeker, figure out the expected degree of matching of the job seeker and the hiring business, eliminate mismatched nominations, and get fewer mismatched application from job seekers; and
(8) get more matched applications that will lead to more efficient hiring activities, and that will also have a strong probability of success in gaining new employees.
C. Putting web pages that are open to interface with the network not only in Server 1 but also in a plurality of various sites 6 (S1-S4) has the following advantages:
(9) Even if the job seeker applies at various sites, the targets of the job seeker and the hiring conditions of selected help-wanted information are shown numerically, and at the same time the degree of matching between the conditions of the selected help-wanted information and the experience and skills of the job seeker is shown numerically so that he/she can make a decision more accurately.
(10) The job seeker can get a lot of help-wanted information and select more suitable conditions among the information provided because the information is provided at various sites 6, and also at Server 1 by automatic matching.
(11) The hiring business can provide help-wanted information to many more job seekers not only in Server 1 but also in various sites.
(12) The hiring business can reduce its hiring procedures because once it registers help-wanted information at Server 1, it can also provide the information at various sites 6.
(13) The hiring business can get more applications because job seekers can apply at Server 1 and also at various sites 6.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

1. A matching system for providing information about positions/help wanted, recruiting, and other related information through the network,
in which the specialized site for information about positions/help wanted is set up by a server connected to the network,
in which the server has an interface, control system, and database,
in which the interface is open to the network, and comprising web pages browsable by personal computer, mobile terminal, etc.,
in which the web pages post necessary information about positions/help wanted, improving careers and skills, etc., and have various registration buttons, etc.,
in which a hiring business enters information about recruiting such as information about job offers and solicited information, etc., at the specialized site for information about positions/help wanted, and also enters prioritized items with plural ranks among the solicited information,
in which job-seekers/certification candidates enter resumes, curriculum vitae, and solicited information, etc., at the specialized site for information about positions/help wanted, and also enter prioritized items with plural ranks among the solicited information,
in which at the specialized site for information about positions/help wanted, based on the input data, the control system automatically matches the information about recruitment of the hiring business with solicited information of job-seekers/certification candidates, and shows numerically the degree of matching, and the figures exceeding a fixed value are displayed for each set of information regarding recruitment of the hiring business,
and subsequently to said figures exceeding a fixed value, the control system automatically matches solicited information of the hiring business with resumes and curriculum vitae of the job seeker/certification candidate, and shows numerically the degree of matching, and the figures are displayed for each set of information regarding recruitment of the hiring business, which shows discrepancies between targets of the job seeker and the hiring business and thus, supports the application procedures.

2. A matching system for providing information about positions/help wanted, recruiting, and other related information through the network,
in which the specialized site for information about positions/help wanted is set up by a server connected to the network,
in which the server has an interface, control system, and database,
in which the interface is open to the network, and comprising web pages browsable by personal computer, mobile terminal, etc.,
in which the web pages post necessary information about positions/help wanted, improving careers and skills, etc., and have various registration buttons, etc.,
and in which various sites connected to the network are provided the same information as the server provides by said control system posting information posted at the interface of the server,
in which a hiring business enters information about recruiting such as information about job offers and solicited information, etc., at the specialized site for information about positions/help wanted, and also enters prioritized items with plural ranks among the solicited information,
in which job-seekers/certification candidates enter resumes, curriculum vitae, and solicited information, etc., at the specialized site for information about positions/help wanted, and also enter prioritized items with plural ranks among the solicited information,
in which at the specialized site for information about positions/help wanted, based on input data, the control system automatically matches the information about recruitment of the hiring business with solicited information of job-seekers/certification candidates, and shows numerically the degree of matching, and the figures are displayed at various sites, and subsequently to said figures, the control system automatically matches solicited information of the hiring business with resumes and curriculum vitae of job seeker/certification candidate, and shows numerically the degree of matching, and the figures are displayed at various sites, which shows any discrepancies between targets of the job seeker and the hiring business and thus, supports the application procedures.

3. In claim 2, a matching system for providing information about positions/help wanted, recruiting, and other related information through the network is characterized in that a hiring business enters information about recruiting such as information about job offers and solicited information, etc., at the specialized site for information about positions/help wanted, and also enters prioritized items with plural ranks among the solicited information, and subsequently selects and registers desired information to be posted at various sites connected to the network,
in which the control system of the specialized site for information about positions/help wanted automatically creates a file (File 1) for posting information regarding recruitment, seminars, etc., particular to the various sites, and saves the information to Server 1, otherwise connects to Server 1 to automatically create a file (File 2) in which a program of providing information regarding recruitment, seminars, etc., is written, and
in which job-seekers/certification candidates enter resumes, curriculum vitae, and solicited information, etc., at the specialized site for information about positions/help wanted, and also enter prioritized items with plural ranks among the solicited information.

4. In claim 1, a matching system for providing information about positions/help wanted, recruiting, and other related information through the network is characterized in that job-seekers/certification candidates enter resumes, curriculum vitae, and solicited information, etc., at the specialized site for information about positions/help wanted, and also enter prioritized items with plural ranks among the solicited information,
in which at the specialized site for information about positions/help wanted, based on both input data, the control system automatically matches the information about recruitment of the hiring business with solicited information of job-seekers/certification candidates, and shows numerically the degree of matching, and the figures exceeding a fixed value are displayed for each set of information regarding recruitment of the hiring business,
and subsequently to said figures exceeding a fixed value, the control system automatically matches solicited information of the hiring business with resumes and curriculum vitae of the job seeker/certification candidate, and shows numerically the degree of matching, and the figures are displayed for each set of information regarding recruitment of the hiring business, which shows any discrepancies between targets of the job seeker and the hiring business, and
in which job-seekers/certification candidates can apply under their own names or under anonymity.

5. In claim 2 and 3, a matching system for providing information about positions/help wanted, recruiting, and other related information through the network is characterized in that job-seekers/certification candidates enter resumes, curriculum vitae, and solicited information, etc., at the specialized site for information about positions/help wanted, and also enter prioritized items with plural ranks among the solicited information,
in which at the specialized site for information about positions/help wanted, based on both input data, the control system automatically matches the information about recruitment of the hiring business with solicited information of job-seekers/certification candidates, and shows numerically the degree of matching, and the figures are displayed for each set of information regarding recruitment of the hiring business at various sites,
and subsequently to said figures, the control system automatically matches solicited information of the hiring business with resumes and curriculum vitae of the job seeker/certification candidate, and shows numerically the degree of matching, and the figures are displayed for each set of information regarding recruitment of the hiring business at various sites,
which shows any discrepancies between targets of the job seeker and the hiring business, and
in which job-seekers/certification candidates who made decisions based on the figures can apply under their own names or under anonymity at various sites,
and furthermore can apply to unregistered hiring businesses based on the matching at their request at the specialized site for information about positions/help wanted.

6. A matching system for providing information about positions/help wanted, recruiting, and other related information through the network,
in which the specialized site for information about positions/help wanted is set up by a server connected to the network,
in which the server has an interface, the control system, and database,
in which the interface is open to the network, and comprising web pages browsable by personal computer, mobile terminal, etc.,
in which the web pages post necessary information about positions/help wanted, improving careers and skills, etc., and have various registration buttons, etc.,
and in which various sites connected to the network are provided the same information as the server provides by said control system posting information posted at the interface of the server,
in which a hiring business enters information about recruiting such as information about job offers and solicited information, etc., at the specialized site for information about positions/help wanted, and also enter prioritized items with plural ranks among the solicited information,
in which job seekers enter resumes, curriculum vitae, and solicited information, etc., at the specialized site for information about positions/help wanted, and also enter prioritized items with plural ranks among the solicited information,
in which at the specialized site for information about positions/help wanted, based on both input data, the control system automatically matches the information about recruitment of the hiring business with solicited information of job-seekers/certification candidates, and shows numerically the degree of matching, and the figures exceeding a fixed value are displayed for each resumes and manuscript of professional activities,
and subsequently to said figures exceeding a fixed value, the control system automatically matches solicited information of the job seeker with information about recruitment of the hiring business, and shows numerically the degree of matching, and the figures are displayed for each solicited information of job-seeker,
which shows any discrepancies between targets of the job seeker and the hiring business, and
in which the hiring business can nominate job seekers under his/her name or under anonymity.

7. A matching system for providing information about positions/help wanted, recruiting, and other related information through the network,
in which the specialized site for information about positions/help wanted is set up by a server connected to the network,
in which the server has an interface, control system, and database,
in which the interface is open to the network, and comprising web pages browsable by personal computer, mobile terminal, etc.,
in which the web pages post necessary information about positions/help wanted, improving careers and skills, etc., and have various registration buttons, etc.,
and in which an hiring business's own site of the hiring business connected to the network are provided information selected by the the hiring business from information posted at the interface of the server by said control system,
in which a hiring business enters information about recruiting such as information about job offers and solicited information, etc., at the specialized site for information about positions/help wanted, and also enters prioritized items with plural ranks among the solicited information,
and in which a job-seeker/certification candidates enters resumes, curriculum vitae, and solicited information, etc., at the hiring business's own site under his/her own name or under anonymity, and also enters prioritized items with plural ranks among the solicited information,
in which said control system automatically matches the information about recruitment of the hiring business with solicited information of job seekers, and shows numerically the degree of matching, and displays it at its hiring business's own site, and subsequently automatically matches the solicited information of the hiring business with resumes and curriculum vitae of job-seekers, and shows numerically the degree of matching, and displays it at hiring business's own site,
which shows any discrepancies between targets of the job seeker and the hiring business,
in which job-seekers/certification candidates who made decisions based on the figures can apply under their own names or under anonymity,
and furthermore receive matching with other hiring businesses at their request at the specialized site for information about positions/help wanted.
